(19) United States
(12) Patent Application Publication
(10) Pub. No.: US 2026/0289698 A1
(43) Pub. Date: Sep. 24, 2026

(54) SYSTEM

(71) Applicant: SoftBank Group Corp., Tokyo (JP)

(72) Inventor: Takafumi OGANE, Tokyo (JP)

(73) Assignee: SoftBank Group Corp., Tokyo (JP)

(21) Appl. No.: 19/567,361

(22) Filed: Mar. 16, 2026

(30) Foreign Application Priority Data
Mar. 19, 2025 (JP) 2025-045249

(51) Int. Cl. G06Q 50/14; G10L 25/63

(52) U.S. Cl. CPC G06Q 50/14; G10L 25/63

(57) ABSTRACT

A system includes a processor configured to receive user information and analyze the information using a generative AI model. Based on the analysis, the processor generates a prompt instructing the model to propose a preferred travel destination. The processor completes accommodation and flight reservations via an API of a travel reservation platform, acquires reservation information, and performs payment using an electronic payment means. The processor further acquires weather information for the travel date and generates a prompt instructing the model to propose necessary belongings based on weather conditions, season, and travel purpose, and notifies the user of a belongings list. An emotion analysis engine analyzes the user's emotional state, and the processor proposes the travel destination and belongings based on the emotional analysis result.

### CROSS-REFERENCE TO RELATED APPLICATION

This application is based on and claims priority under 35 USC 119 from Japanese Patent Application No. 2025-045249 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel support systems suffer from several limitations when assisting a user in planning and executing a trip. First, in many existing systems, travel destination recommendation, reservation of accommodations and flights, payment processing, and preparation of belongings are handled by separate services, requiring the user to manually move between different platforms and repeatedly input similar information. Second, typical recommendation engines rely mainly on static rules or simple profile data and are not capable of flexibly interpreting natural language input or complex user intentions, which results in travel proposals that may not sufficiently reflect the user's detailed preferences or situational context. Third, conventional systems generally do not take into account the user's emotional state when proposing destinations or belongings, thereby missing opportunities to adapt travel plans to the user's psychological condition, such as stress, anxiety, or desire for relaxation. Fourth, while some services may provide basic weather forecasts, they do not comprehensively combine day-of-travel weather information, seasonal factors, travel purpose, and user preferences to generate a personalized belongings list and timely notifications. Accordingly, there is a need for an integrated system that can: (i) interpret user input and history using a generative AI model; (ii) automatically propose suitable travel destinations; (iii) complete reservations and electronic payments; (iv) dynamically propose necessary belongings based on weather, season, and travel purpose; and (v) further refine such proposals based on the user's emotional state.

### SUMMARY

To solve the above-described problems, an embodiment of the present invention provides a system comprising a processor configured to perform a series of integrated operations by cooperating with a generative AI model, an emotion analysis engine, a travel reservation platform, and an electronic payment means. The processor receives information from a user and analyzes the received information by using the generative AI model to perform information analysis. Based on an analysis result obtained from the information analysis, the processor inputs a prompt to the generative AI model to propose a preferred travel destination for the user. The processor then completes reservations of accommodations and aircraft via an API of a travel reservation platform based on the proposed travel destination, acquires reservation information, and completes payment by using the electronic payment means. Further, the processor acquires day-of-travel weather information and inputs a prompt to the generative AI model to propose necessary belongings according to a weather condition and a season at the user's travel destination and a purpose of travel, and notifies a belongings list generated by the generative AI model to the user. In addition, the processor analyzes input information from the user by using the emotion analysis engine to analyze an emotional state of the user, and proposes the travel destination and the belongings based on an emotion analysis result obtained from the emotion analysis engine. In some embodiments, the processor acquires a past travel history and preferences of the user from a database, generates a prompt that instructs generation of the travel destination based on the past travel history and the preferences, and inputs the prompt to the generative AI model to propose the travel destination. In other embodiments, the processor generates a prompt that instructs generation of the belongings list according to the weather condition and the season at the user's travel destination and the purpose of travel, inputs the prompt to the generative AI model, and notifies the belongings list generated by the generative AI model to the user. Through these means, the system integrally supports travel planning, reservation, payment, and preparation of belongings in a manner that is dynamically tailored to the user's preferences, context, and emotional state.

The term “system” refers to an integrated arrangement of hardware, software, and network resources that cooperatively execute processing for travel recommendation, reservation, payment, and belongings suggestion according to the present invention.

The term “processor” refers to one or more hardware processing units, such as a central processing unit (CPU), graphics processing unit (GPU), or dedicated accelerator, and associated control circuitry configured to execute programs or instructions to perform the functions described in the claims.

The term “user” refers to a person who interacts with the system by providing input information, such as travel preferences or natural language messages, and who receives outputs such as travel destination proposals, reservation confirmations, and belongings lists.

The term “information from a user” refers to any data acquired from the user, including but not limited to natural language text, voice input converted to text, structured form data, travel dates, departure locations, budgets, travel purposes, and feedback regarding proposed travel plans.

The term “generative AI model” refers to a machine learning model, such as a large language model or other generative model, that is trained to generate text or other content in response to input prompts and that is used to analyze user information or generate travel-related proposals in the present invention.

The term “information analysis” refers to processing performed by the generative AI model or other analytical components to interpret and derive meaning from the information received from the user, including extraction of preferences, intents, constraints, emotional cues, and contextual details.

The term “prompt” refers to text or other structured input data generated by the processor and supplied to the generative AI model, the prompt instructing the generative AI model to perform a specific task, such as proposing a travel destination or generating a belongings list.

The term “preferred travel destination” refers to one or more travel locations proposed for the user by the system based on analysis of the user's information, such as preferences, past travel history, current requirements, and emotional state.

The term “travel reservation platform” refers to an external or internal system or service that provides reservation functions for accommodations, aircraft, and optionally other travel-related services, and that is accessible via one or more application programming interfaces (APIs).

The term “API of a travel reservation platform” refers to an application programming interface provided by the travel reservation platform, through which the processor can send reservation requests, receive availability information, and obtain reservation confirmations for accommodations and aircraft.

The term “accommodations” refers to lodging facilities that can be reserved by the system, such as hotels, inns, hostels, vacation rentals, or other places where a user can stay during travel.

The term “aircraft” refers to commercial or private flights or air transportation services that can be reserved by the system as part of a user's travel itinerary.

The term “reservation information” refers to data indicating details of confirmed or tentative bookings, including but not limited to reservation identifiers, accommodation details, flight details, dates, times, prices, and conditions of use.

The term “electronic payment means” refers to one or more systems, methods, or services that enable electronic processing of payment transactions, such as credit card payment gateways, digital wallets, online banking interfaces, or other electronic settlement mechanisms.

The term “day-of-travel weather information” refers to weather data corresponding to the day on which the user departs or travels, including information such as weather conditions, temperature, precipitation, and other relevant meteorological parameters at or near the travel destination.

The term “weather condition” refers to a state of the atmosphere at the travel destination, including but not limited to clear, cloudy, rainy, snowy, windy, or stormy conditions, and may also encompass qualitative descriptions such as hot, cold, or humid.

The term “season” refers to a period of the year associated with particular climatic characteristics, such as spring, summer, autumn, or winter, and may also refer to region-specific seasonal classifications that influence the type of belongings suitable for travel.

The term “purpose of travel” refers to the user's intended objective or context for the trip, including but not limited to leisure, business, sightseeing, adventure, relaxation, or visiting family, as indicated or inferred from the user's input.

The term “necessary belongings” refers to items that are recommended for the user to carry or prepare for a trip, determined based on the travel destination, weather condition, season, purpose of travel, and user-specific factors.

The term “belongings list” refers to a list of necessary belongings generated by the generative AI model or the processor, the list specifying concrete items such as clothing, accessories, documents, and other objects to be prepared by the user.

The term “notification” refers to a communication from the system to the user that presents information such as the generated belongings list, and may be realized through a user interface on a terminal, a push notification, an email, or any other suitable output mechanism.

The term “emotion analysis engine” refers to a software and/or hardware component configured to analyze user input, such as text or speech, to determine an emotional state of the user using techniques including sentiment analysis, emotion classification, or other affective computing methods.

The term “emotional state of the user” refers to an inferred or estimated psychological condition of the user, such as happiness, sadness, stress, anxiety, excitement, or calmness, derived from the user's input using the emotion analysis engine.

The term “past travel history” refers to data describing the user's previous trips, including destinations, dates, durations, activities, feedback, and associated preferences, stored in a database and retrievable by the processor.

The term “preferences of the user” refers to the user's likes, dislikes, and tendencies related to travel, such as preferred climate, activity types, budget levels, accommodation standards, or cultural interests, obtained from explicit settings or inferred from past behavior and inputs.

The term “database” refers to an information storage system, such as a relational database, NoSQL store, or other persistent storage, that maintains user profiles, past travel histories, preferences, reservation records, and other data utilized by the processor.

The term “analysis result” refers to output data produced by the information analysis performed by the generative AI model or other analytical components, indicating interpreted meanings, extracted features, inferred preferences, or other processed information derived from the user's input.

The term “emotion analysis result” refers to output data produced by the emotion analysis engine, indicating the detected or inferred emotional state or sentiment of the user, and optionally including associated scores, categories, or confidence levels.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

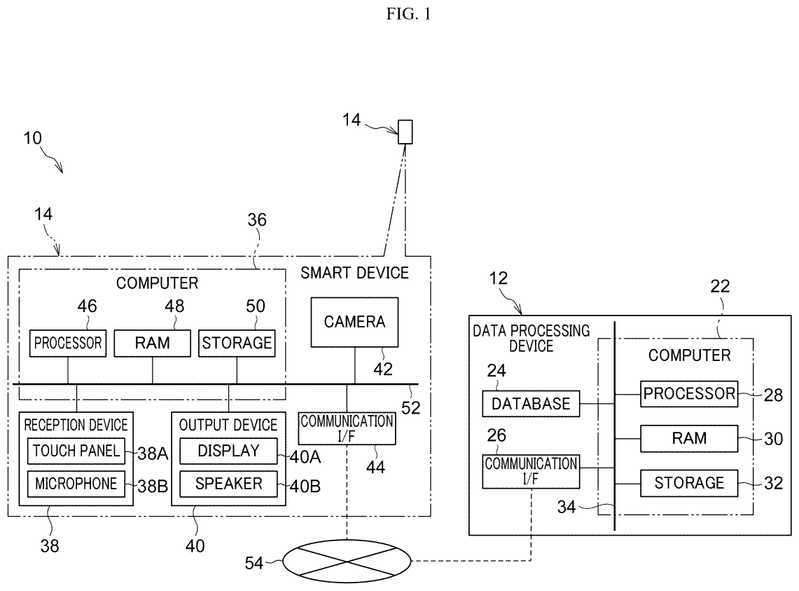

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

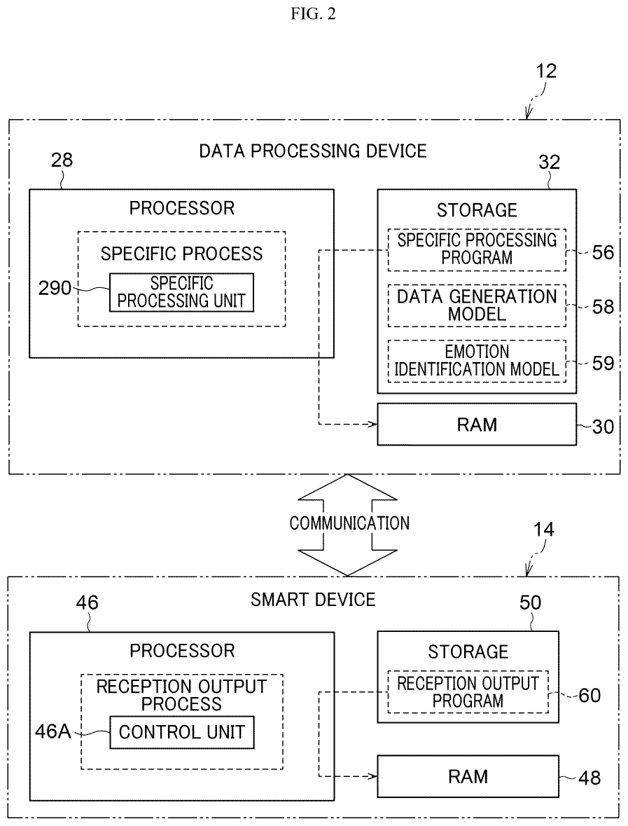

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems typically treat recommendation, reservation, payment, and travel-day assistance as disjoint processes executed by separate software modules or external services. In many implementations, a travel recommendation engine merely outputs a static list of destinations based on limited profile attributes, while reservation systems operate on rigid forms and predefined workflows. As a result, these systems require the user to manually bridge gaps between natural language intent and machine-readable reservation parameters, to manually re-enter similar information into multiple interfaces, and to repeatedly adjust search queries when preferences change. This fragmented architecture increases latency, consumes unnecessary computing resources due to redundant processing, and leads to brittle user interfaces that are not robust to ambiguous or emotional user input.

Furthermore, in typical systems, any use of a generative AI model is limited to front-end assistance, such as generating text descriptions, without using the model as a core computational component to structure internal data, orchestrate external service calls, or adapt to a user's emotional state. Sentiment information contained in user messages is often discarded, leading to recommendations that technically satisfy constraints but do not align with user satisfaction or comfort. Similarly, context such as weather conditions, season, and travel purpose is often processed by ad-hoc rule sets that do not scale well to diverse scenarios and require manual maintenance.

In addition, existing systems generally do not provide an integrated mechanism for translating heterogeneous contextual data—such as past behavior history, current natural language intent, forecast weather data, and emotional state—into machine-usable representations that can drive reservation, payment, and travel-day preparation in a unified workflow. Multiple loosely coupled modules result in duplicated parsing logic, inconsistent interpretation of user preferences, and increased failure points in communicating with external reservation and payment services. This leads to inefficient CPU and memory usage, increased network overhead due to unnecessary retries and mismatched parameters, and difficulty in maintaining data consistency across the lifecycle of a trip.

There is therefore a need for an improved computer-implemented system and processing architecture that transforms natural language dialog, user history, external service responses, and contextual parameters into a coherent, machine-interpretable control flow. Such a system should leverage a generative AI model not merely as an auxiliary text generator, but as a central computational component that operates on structured prompt sentences, integrates sentiment analysis, and produces structured outputs suitable for direct use by reservation and payment application programming interfaces. By doing so, the system can reduce redundant computations, improve the accuracy and robustness of mapping user intent to system actions, and provide a more efficient and adaptive travel-planning pipeline.

The specific processing by the specific processing unit 290 of the data processing device 12 in Example 1 is realized by the following means.

The present invention provides a server comprising a processor configured to receive natural language travel-related information from a user terminal, acquire past behavior history information and preference information of a user from an information storage device based on the natural language information and user identification information, generate analysis input text in the form of prompt sentences including the past behavior history information, the preference information, and the natural language information, input the analysis input text into a generative AI model to cause the generative AI model to generate candidate sets of travel destinations suitable for the user, extract travel destination candidates from outputs of the generative AI model, and present the travel destination candidates to the user terminal while acquiring travel destination selection information and schedule information from the user terminal; the processor being further configured to generate reservation request data based on the travel destination selection information and the schedule information, call one or more external reservation application programming interfaces of travel reservation information processing devices using the reservation request data to execute reservation processing for accommodation services and transportation services, and acquire reservation result information as structured machine-readable data; the processor being further configured to generate payment request data based on the reservation result information, call a payment processing service application programming interface to complete electronic payment processing, and store payment result information in association with the reservation result information; the processor being further configured to acquire weather information for a travel period from a weather information providing device based on travel destination information and date information included in the reservation result information, generate description input text as prompt sentences including the weather information, a travel destination type, a season, and a travel purpose, and input the description input text into the generative AI model to cause the generative AI model to generate a packing list including a list of items to be carried; the processor being further configured to notify the user terminal of the packing list together with the weather information, analyze expressions included in additional natural language input from the user using a sentiment analysis engine to extract an emotional state of the user, incorporate information representing the emotional state into at least one of the analysis input text and the description input text, re-input emotional-state-augmented prompt sentences into the generative AI model so that the generative AI model adjusts at least one of the travel destination candidates and the packing list according to the emotional state, and iteratively update a travel plan and the packing list in response to additional condition inputs from the user by generating and supplying revised prompt sentences to the generative AI model. This enables an integrated computer-implemented workflow in which natural language dialog, historical data, weather context, and emotional context are transformed into structured control signals for external reservation and payment interfaces, thereby reducing redundant parsing and rule-based logic, improving computational efficiency and robustness in mapping user intent to concrete system actions, and enhancing the adaptability and technical performance of the travel planning and preparation processes executed by the server.

The term “system” refers to a collection of hardware and software components that cooperate to execute the claimed processing, including at least one server device and one or more user terminals interconnected via a communication network.

The term “processor” refers to one or more hardware processing units, such as a central processing unit or other computing circuitry, configured to execute instructions stored in a memory to perform the functions described in the claims.

The term “user terminal” refers to an information processing device operated by a user, such as a mobile communication device, a portable computing device, or a stationary computing device, that provides a user interface for inputting and receiving information related to travel.

The term “natural language information” refers to text or speech content expressed in a human language, such as user utterances describing travel wishes, constraints, or preferences, which is processed by the system without requiring a formal command syntax.

The term “user identification information” refers to data that uniquely or pseudonymously identifies a user, such as an account identifier, a session identifier, or a device identifier, and that is used to associate inputs with stored data.

The term “information storage device” refers to one or more storage units, such as a database system or non-volatile memory, that store past behavior history information, preference information, reservation information, and other data processed by the system.

The term “past behavior history information” refers to data representing historical actions of a user related to travel, including previously visited locations, prior reservations, historical budgets, and selected travel types.

The term “preference information” refers to data representing user tendencies and likes, such as favored destination categories, accommodation types, transportation modes, budget ranges, and activity types.

The term “prompt sentence” refers to a text string or sequence of tokens constructed by the processor to instruct a generative AI model to perform a specific processing task, such as generating travel destination candidates or generating a packing list.

The term “analysis input text” refers to a prompt sentence that includes natural language information from a user and one or more of past behavior history information and preference information, and that is supplied to a generative AI model for the purpose of generating travel destination candidates.

The term “description input text” refers to a prompt sentence that includes information such as weather information, a travel destination type, a season, and a travel purpose, and that is supplied to a generative AI model for the purpose of generating a packing list.

The term “generative AI model” refers to a computer-implemented machine learning model, such as a neural network language model, configured to generate output text or structured data in response to input prompt sentences.

The term “travel destination candidate” refers to a proposed travel location, such as a region, city, or area, that is generated or selected based on outputs of the generative AI model in accordance with user preferences.

The term “travel destination selection information” refers to data indicating one or more travel destination candidates chosen by a user, including identifiers of the destinations and associated selection parameters.

The term “schedule information” refers to data indicating temporal aspects of a planned trip, including date information, duration, and, optionally, departure and return times.

The term “date information” refers to data specifying one or more calendar dates related to a trip, such as a departure date and a return date.

The term “number-of-travelers information” refers to data indicating a quantity of persons for whom travel is planned.

The term “budget information” refers to data indicating monetary constraints or ranges for costs of travel, including accommodation and transportation.

The term “reservation request data” refers to structured data prepared by the processor for transmission to an external reservation application programming interface, the data including parameters such as destination, dates, traveler count, and preferences.

The term “travel reservation information processing device” refers to an external information processing system that provides reservation services for travel, including services for accommodation and transportation, via one or more application programming interfaces.

The term “reservation application programming interface” refers to an interface provided by a travel reservation information processing device through which the processor can send reservation request data and receive reservation result information.

The term “accommodation service” refers to a service providing temporary lodging for travelers, such as a facility reservation or stay arrangement.

The term “transportation service” refers to a service providing travel conveyance for travelers, such as air transport, rail transport, or other transport means.

The term “reservation result information” refers to structured data returned from a reservation application programming interface, including reservation identifiers, confirmed dates, and details of reserved accommodation and transportation.

The term “payment request data” refers to structured data generated by the processor for transmission to a payment processing service application programming interface, the data including payment amounts, currency information, and payment method information.

The term “payment processing service” refers to an external service system that executes electronic payment transactions on behalf of the system, such as by charging a stored payment instrument.

The term “payment processing service application programming interface” refers to an interface provided by a payment processing service, through which the processor transmits payment request data and receives payment result information.

The term “payment result information” refers to structured data indicating a result of a payment transaction, including success or failure status and transaction identification information.

The term “weather information providing device” refers to an external information processing system that supplies weather information via a communication interface, based on location and time parameters.

The term “weather information” refers to data representing meteorological conditions for a given location and time period, including temperature, precipitation, and weather conditions.

The term “travel destination type” refers to classification data indicating a category of a travel destination, such as beach region, urban region, or hot spring region.

The term “season information” refers to data indicating a temporal season or period, such as summer, winter, or a particular date range, associated with travel.

The term “travel purpose” refers to data indicating a main intent of a trip, such as leisure, business, sightseeing, or relaxation.

The term “packing list” refers to a list of items to be carried by a user for a trip, generated based on contextual parameters such as weather information and travel purpose.

The term “sentiment analysis engine” refers to a software component or service configured to analyze natural language input and output data representing an emotional state of a user.

The term “emotional state” refers to data representing an inferred psychological or affective condition of a user, such as stress level, excitement level, or preference intensity, derived from analysis of the user's natural language input.

The term “emotional-state-augmented prompt sentence” refers to a prompt sentence that incorporates information representing an emotional state into analysis input text or description input text to influence outputs of the generative AI model.

The term “additional condition input” refers to natural language information or structured information provided by a user after an initial plan or list has been generated, indicating modifications, constraints, or refinements to a travel plan or packing list.

The term “travel plan” refers to an aggregated representation of a user's intended trip, including at least a selected travel destination, a schedule, and associated reservation information.

The term “notification” refers to data transmitted by the processor to a user terminal for presentation to a user, such as messages containing travel destination candidates, reservation summaries, weather information, or packing lists.

In one embodiment, a server cooperates with one or more terminals operated by users to implement the claimed system. The server includes at least one processor, a main memory such as dynamic random-access memory, a non-volatile storage device such as a magnetic disk or solid-state drive, and a network interface configured to communicate over an IP-based network. The terminal includes a processor, a memory, a display unit, an input unit such as a touch panel or keyboard, and a communication interface. The server and the terminal execute software modules including an operating system (for example, a general-purpose server operating system on the server and a mobile or desktop operating system on the terminal), a database management system on the server (for example, a relational database engine), and an application program implementing the travel assistance functions described herein.

The server executes a program that causes the processor to function as multiple logical modules, including a communication module, a user data management module, a prompt generation module, a generative AI model interface module, a destination selection module, a reservation interface module, a payment interface module, a weather information interface module, a packing list generation module, and a sentiment analysis module. These logical modules may be implemented as functions, classes, or microservices that exchange data through defined interfaces and shared data structures in memory and storage.

The server maintains an information storage device configured as a database that stores, for each user, records of past behavior history information and preference information. The past behavior history information is stored in normalized tables, for example including a user table, a trip table, and a reservation detail table. Each trip record includes fields such as a destination identifier, start and end dates, cost, accommodation type category, and transportation type category. The preference information is stored as a combination of categorical attributes (for example, preferred destination categories, preferred accommodation categories, typical budget ranges) and numerical vectors representing latent preferences. The numerical vectors can be pre-computed by embedding user behavior sequences using a machine learning model and stored as fixed-length arrays in the database.

The server stores destination information in another database table that maps human-readable destination names to normalized identifiers, coordinates, destination category labels (for example, beach region, urban region, mountain region, hot spring region), and links to external reservation provider identifiers. This structured storage allows the server to convert generative AI outputs expressed in natural language into machine-processable identifiers for subsequent reservation processing.

The server uses a generative AI model that implements a transformer-based neural network architecture. In one embodiment, the generative AI model includes an input token embedding layer, multiple self-attention layers, feed-forward layers, and a softmax output layer over a token vocabulary. The model is trained as a language model on a corpus including travel-related texts, system prompts, and example dialogues. The model parameters (weights of the attention and feed-forward layers) are stored in a dedicated model storage and are loaded into random-access memory and, where available, into a graphics processing unit memory. The server uses a hardware accelerator such as a general-purpose graphics processing unit to perform matrix multiplications and attention computations, thereby decreasing inference time compared to a purely central-processing-unit-based implementation.

The server configures the generative AI model interface module to accept a prompt sentence as input and to output either natural-language text or constrained structured text. The prompt sentence is constructed by the prompt generation module and encoded as a sequence of tokens by a tokenizer algorithm corresponding to the vocabulary of the generative AI model. The tokenizer converts each character sequence into integer token identifiers. The server stores the sequence of token identifiers in memory and passes the sequence to the generative AI model running in an inference service process.

The server uses a sentiment analysis engine implemented, for example, as a classifier neural network. The sentiment analysis engine receives tokenized user sentences and outputs vector representations of emotional state, such as a multi-dimensional vector where each dimension corresponds to a particular affective label (for example, calmness, excitement, stress, uncertainty) with a probability or score. The sentiment analysis engine is trained by supervised learning on labeled emotion datasets. During training, the server minimizes a loss function such as cross-entropy between predicted and true emotion labels by adjusting network weights using gradient-based optimization, such as stochastic gradient descent or an adaptive optimizer. During inference, the server uses the trained weights to compute the emotional state vector for each user input without further learning.

The server integrates the emotional state vector into the prompt sentences used for the generative AI model. For example, the server constructs a prompt sentence of the following form:
“User request: ‘I want to go to a beach resort on my next vacation.’
User emotional state: high stress, low excitement.
User past trips: coastal regions and relaxation-oriented stays.
Based on this, propose travel destinations that are quiet, less crowded, and suitable for stress relief. Provide several candidate destinations and short reasons.”

By explicitly embedding the emotional state in text, the server converts numerical emotion features into a representation that the generative AI model can interpret without modification of the model architecture. Alternatively, in another embodiment, the server concatenates an encoding of the emotional state vector directly to the token embeddings before the first transformer layer and adjusts the model architecture accordingly.

The server uses the prompt generation module to construct analysis input text for destination generation. The server retrieves, from the information storage device, the user's past trip records and preference categories and converts them into text segments. The server then concatenates these segments with the latest natural language request into a prompt sentence that specifies, in explicit instructions, the number of destination candidates, the desired output format, and any constraints to be honored. Example prompt sentences include:
“The user wrote: ‘I want to go to a beach resort on my next vacation.’
User past trips: two coastal trips, one tropical island trip, one city break.
Generate 5 recommended beach destinations that match the user's past preferences. For each destination, output a brief explanation and an approximate cost level.”
“The user wrote: ‘I want to go to a hot spring next weekend.’
User past trips: multiple hot spring stays within domestic regions.
Recommend several hot spring areas reachable within 3 hours from a major city. For each area, output typical travel time, recommended length of stay, and why it matches the user's preferences.”

The server supplies these prompt sentences to the generative AI model. At inference time, the generative AI model performs multi-head self-attention over the token embeddings to compute context-aware internal representations. Attention weights are computed as scaled dot products between query and key vectors, normalized by a softmax function. The model then generates output tokens sequentially, at each step selecting the next token according to a probability distribution computed from the final layer's output. To control output form, the server may restrict decoding using nucleus sampling or top-k sampling, and, in one embodiment, the server instructs the model in the prompt to output simple delimited text that can be parsed deterministically.

The server receives the generated text and performs parsing and normalization. For example, when the model outputs a list of destinations and reasons, the server scans the text for known markers, such as line breaks and numbering tokens, and maps destination names to stored destination identifiers using a lookup table. The server thereby transforms inherently ambiguous natural-language output into a normalized data structure containing destination identifiers, destination categories, textual descriptions, and estimated cost levels. This data structure is stored in volatile memory and can be serialized into structured messages transmitted to the terminal.

The terminal displays the destination candidates on a user interface, for example as a list or card-type element. The user can select one or more destinations and specify additional constraints, such as desired dates, maximum budget, desired accommodation class, and preferred transportation type. The terminal sends these selections to the server in a structured format. The server converts the user's selections into reservation parameters, including normalized dates, destination identifiers, number of travelers, fare classes, and room types. The server uses the reservation interface module to interact with external reservation application programming interfaces. The module formats HTTP requests that include the normalized parameters as query strings or request bodies, using protocols defined by the external reservation providers. The server also includes authentication tokens or keys in the request headers. When the external reservation information processing devices respond with available options, typically in structured formats, the server parses these responses using predetermined schemas. The server collects fields such as price, availability, airline codes, lodging facility categories, and cancellation conditions and stores them in data structures such as arrays of offer objects.

In one embodiment, the server again uses a generative AI model to summarize or filter the large number of offers based on user preferences. The server constructs a prompt sentence describing the list of available options in simplified textual form and adds explicit instructions about how to select or rank them. An example prompt sentence is:
“Here are 10 hotel options in a coastal region. Each option has a price level, a guest rating, and a distance to the beach. The user prefers quiet, high-rating hotels near the beach and has a medium budget. Analyze the list and recommend the 3 best options. For each recommended option, provide a short explanation.”

The generative AI model produces a smaller subset of recommended options with textual justifications. The server reconstructs this subset by mapping hotel names or identifiers from the generated text back to the structured offer list. The server thereby uses the AI model not to make bookings directly, but to perform a complex, multi-criteria reduction of a large search space into a smaller, user-specific set. This reduction step improves computational efficiency by preventing the server and the terminal from rendering or transmitting unnecessarily large data sets.

The server uses the payment interface module to generate payment request data after the user confirms a specific plan. The server calculates total cost values from the selected offer data, including taxes, fees, and possible currency conversions, using arithmetic operations and reference tables. The server constructs payment messages containing the total amount, currency, and user payment method tokens. Communication with payment processing services occurs over secure channels. The server receives payment result information, including success or failure status and transaction identifiers, and stores this data linked to reservation records. This structured linkage enables consistent state management across reservation and payment components and reduces the risk of inconsistency between booked services and completed payments.

The server retrieves weather information for the confirmed travel destination and dates using the weather information interface module. The module performs requests to an external weather information providing device using standardized APIs. The server receives forecast data and stores it in a weather table or a cache store indexed by destination and date. The packing list generation module uses this weather data, together with destination category, season, and travel purpose, to construct description input text as a prompt sentence.

Example prompt sentences for packing list generation include:
“Destination: coastal resort, stay of 7 days, two adults.
Weather forecast: daytime temperatures 28-32 degrees Celsius, sunny with occasional showers.
Travel purpose: relaxation and beach activities.
Generate a detailed packing checklist grouped by categories (Clothing, Toiletries, Electronics, Documents, Others). Include specific items appropriate for the weather and travel purpose.”
“Destination: mountain hot spring area, weekend stay, one adult.
Weather forecast: cold temperatures with possible rain.
Travel purpose: relaxation and walking.
Generate a packing list with warm clothing, items for hot spring use, and rain protection. Present the items as bullet points.”

The server tokenizes these description input texts, runs them through the generative AI model, and obtains lists of natural-language items. The server may post-process the items by normalizing item names and grouping them according to categories. The terminal displays the packing list and corresponding weather forecast to the user, allowing the user to prepare physically for the travel.

From a technical standpoint, the described integration of generative AI models, sentiment analysis, and structured interfaces yields several improvements over conventional architectures. The server reduces redundant data transformation by establishing stable internal representations (destination identifiers, user preference vectors, emotion vectors) and by standardizing prompt sentence patterns. This consistency allows the server to avoid repeated parsing and re-interpretation of user inputs at each stage of the workflow, thereby reducing CPU utilization and latency.

The server improves accuracy and robustness in mapping user intent to reservation parameters by using prompt sentences that explicitly incorporate multiple data sources—user history, preferences, emotional state, weather data—into a single, context-rich input to the generative AI model. Instead of requiring multiple separate rule engines, the generative AI model can generate coherent outputs that directly conform to specified structural guidelines. This reduces the need for post-hoc correction and heuristic filtering, which in conventional systems often result in errors or misalignment between user intent and machine actions. The server also improves data management and communication efficiency. Because the server normalizes generative outputs into identifiers and structured objects before interacting with external reservation and payment systems, the server can batch requests, cache frequent results, and minimize unnecessary network calls. For example, if the generative AI model repeatedly suggests the same popular destinations or hotel categories, the server can reuse previously retrieved reservation options from cache rather than issuing new search requests. This reduces network load and external service usage.

In another embodiment, the server supports alternative implementations of the generative AI model. For example, the server may use a sequence-to-sequence encoder-decoder architecture, where an encoder network converts the prompt sentence into a context vector and a decoder network generates the output sequence. The server may also adjust model parameters such as the number of attention heads, the number of layers, and the hidden dimension size to trade off between inference speed and output quality. During deployment, the server uses quantization techniques or model distillation to compress the model for faster inference, further reducing computing resource consumption.

The server trains the generative AI model using supervised or semi-supervised learning with training data comprising examples of desired outputs for given prompt sentences. During training, the server minimizes a sequence-level loss function such as cross-entropy between generated tokens and target tokens. The server may further fine-tune the model using reinforcement learning from human feedback, where human evaluators rate model suggestions and the server uses these ratings to adjust model parameters. Through such fine-tuning, the model learns domain-specific patterns, such as how to trade off price and comfort or how to respond appropriately to certain emotional states, without the need to hard-code those trade-offs in traditional rule engines.

The described system provides technical benefits beyond mere automation of human tasks. Humans may manually read travel information, check weather forecasts, and decide what to pack, but cannot feasibly maintain up-to-date knowledge of reservation system APIs, normalize large volumes of candidate offers, or integrate emotional state vectors into every decision in real time. By structuring the entire process around machine-interpretable prompt sentences, optimized neural networks, and standardized data structures, the server achieves improved processing speed, reduced error rates in mapping natural-language requests to reservations, and more efficient utilization of network and computing resources.

In yet another embodiment, the server resides in a distributed computing environment in which different modules run on separate physical or virtual machines. For example, a dedicated model inference node hosts the generative AI model, a database node hosts storage components, and an application node orchestrates business logic. The communication between nodes uses serialized messages with well-defined schemas. This modular architecture allows horizontal scaling and enhances fault tolerance.

In another embodiment, the terminal may be implemented as a web browser executing client-side scripts, or as a native application on a mobile device. The terminal can perform preliminary natural-language preprocessing, such as tokenization for on-device sentiment estimation, before sending data to the server. In some configurations, the terminal may cache frequently used packing list templates or destination summaries to reduce repeated downloads, further decreasing communication overhead.

Across these embodiments, the server, the terminal, and the described software modules cooperate to implement the system defined in the claims. The server uses a generative AI model and structured prompt sentences in a non-conventional way: as core computational elements that produce machine-usable outputs for controlling reservation, payment, and notification workflows, while integrating heterogeneous data sources such as history, preferences, weather, and emotion. This integrated, technically detailed architecture enables the claimed improvements in computational efficiency, accuracy, robustness, and communication performance.

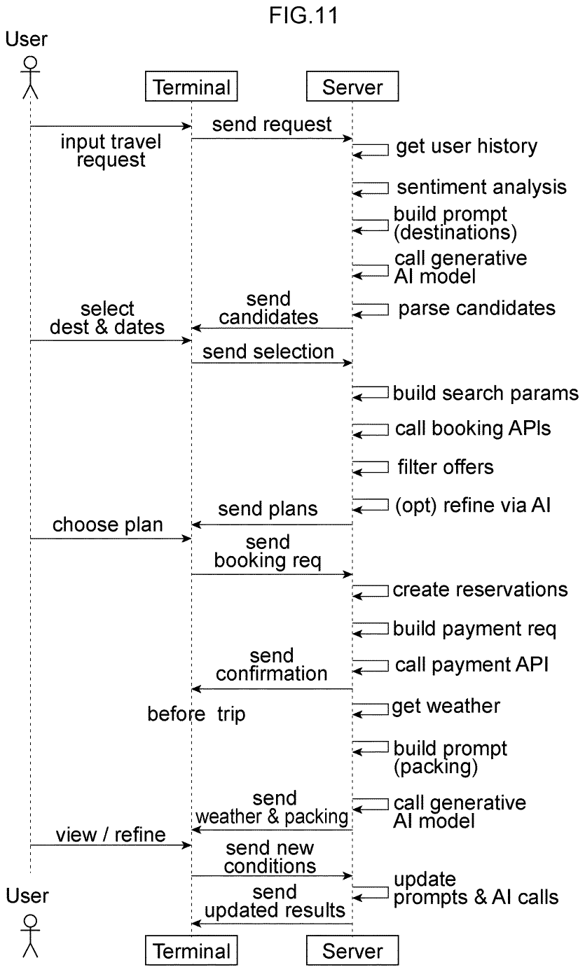

The following describes the processing flow using FIG. 11.

### Step 1

The user operates the terminal to start a travel planning session and inputs natural language information.
The user enters, via a keyboard, touch panel, or microphone, a travel-related request such as “I want to go to a beach resort on my next vacation” or “I want to go to a hot spring next weekend.”
Input: raw natural language text (or speech converted to text) representing the user's travel intent.
Output: a structured message at the terminal containing the text, a user identifier, and a timestamp, ready to be sent to the server.

### Step 2

The terminal transmits the user's input to the server.
The terminal encapsulates the text, the user identifier, and session information into a structured request (for example, JSON over HTTPS) and sends it through a network interface to a designated server endpoint.
Input: user's natural language text, user identifier, session identifier.
Output: a network packet containing the structured request delivered to the server.

### Step 3

The server receives and authenticates the request from the terminal.
The server parses the incoming request, verifies an authentication token or session information, checks format validity, and extracts the user identifier and natural language text from the request body.
Input: structured request from the terminal containing user text and identification data.
Output: internal variables in server memory holding the sanitized user text, user identifier, and session context.

### Step 4

The server retrieves past behavior history information and preference information for the user.
The server issues database queries (for example, SQL SELECT statements) to an information storage device, using the user identifier as a key to obtain past trips, preferred destination types, typical budget ranges, and other stored attributes. The server may also retrieve pre-computed preference vectors associated with the user.
Input: user identifier and a database connection.
Output: structured data representing past behavior history (trip records) and preference information (categories and vectors) loaded into server memory.

### Step 5

The server performs sentiment analysis on the user's natural language text.
The server applies a tokenizer to the user text, converts tokens to numerical embeddings, and feeds them into a sentiment analysis engine (for example, a neural classifier). The sentiment analysis engine computes an emotional state vector by applying matrix multiplications and non-linear activation functions, then outputs scores for affective dimensions such as stress, excitement, and uncertainty.
Input: user's natural language text.
Output: an emotional state representation (for example, a multi-dimensional vector or labeled scores) stored as part of the current context.

### Step 6

The server generates an analysis input prompt sentence for a generative AI model.
The server concatenates the user's current request, the past behavior history summary, the preference information, and the emotional state description into a single text instruction. The server formats the text to specify output requirements, such as number of destination candidates and explanation fields.
Example analysis prompt sentence:
“User request: ‘I want to go to a beach resort on my next vacation.’
User emotional state: high stress, low excitement.
User past trips: several coastal stays and relaxation-focused trips.
User preferences: quiet places, mid-range budget.
Based on this information, propose 5 beach destinations suitable for stress relief. For each destination, provide a name, a brief explanation, and an approximate cost level.”
Input: user text, history data, preference data, emotional state data.
Output: a single analysis input prompt sentence string stored in memory.

### Step 7

The server invokes the generative AI model with the analysis input prompt sentence.
The server tokenizes the prompt sentence, maps tokens to integer IDs, and passes the token sequence to a transformer-based generative AI model executed on a hardware accelerator or CPU. The model computes attention scores, hidden states, and probability distributions to generate an output token sequence that describes travel destination candidates and reasons.
Input: tokenized analysis input prompt sentence.
Output: generated text containing candidate travel destinations and explanations, represented as a sequence of tokens and then as a decoded character string.

### Step 8

The server parses and normalizes the generated destination candidates.
The server scans the generated text for line breaks, numbering, or delimiters, and splits the text into individual entries. For each entry, the server extracts the destination name, explanation, and cost level. The server then matches destination names against a destination master table to obtain normalized destination identifiers and category labels.
Input: generated text describing destination candidates.
Output: a structured list of destination candidate objects, each containing a destination identifier, a normalized name, a category, an explanation, and an estimated cost level.

### Step 9

The server transmits the destination candidates to the terminal.
The server formats the list of destination candidate objects into a response message (for example, JSON) and sends the message via its network interface to the terminal along with any meta-information such as request identifiers.
Input: structured destination candidate list.
Output: a network response containing the destination candidate list delivered to the terminal.

### Step 10

The terminal displays destination candidates and accepts the user's selection and constraints.
The terminal parses the received candidate list and renders it on the display as selectable items, each showing name, explanation, and approximate cost. The user selects one or more destinations and optionally enters or selects dates, number of travelers, and budget constraints using the terminal's input unit.
Input: destination candidate list from the server and user interactions via the UI.
Output: a structured selection record containing chosen destination identifier(s), selected dates, number of travelers, and budget constraint.

### Step 11

The terminal sends the selection record to the server.
The terminal embeds the selection record, the user identifier, and session information in a request message and sends the message to a server endpoint responsible for reservation planning.
Input: user's destination selection and constraint data.
Output: a structured request delivered to the server containing all planning parameters.

### Step 12

The server validates the selection and constructs reservation parameters.
The server checks that the selected destination identifiers exist, verifies that the date range is valid and within allowed limits, and ensures that numerical fields (number of travelers, budget) are within expected bounds. The server then constructs normalized reservation parameters such as location codes, time intervals, traveler count, and budget range.
Input: selection record from the terminal and destination master data.
Output: validated and normalized reservation parameters stored in server memory.

### Step 13

The server queries external reservation application programming interfaces for available options.
The server uses the normalized reservation parameters to construct request messages for one or more external reservation systems. The server specifies parameters such as destination codes, check-in and check-out dates, and number of travelers in HTTP requests, and sends them over the network. The external systems return structured responses listing available transportation and accommodation options.
Input: normalized reservation parameters.
Output: raw result data from external reservation APIs, including lists of offers with attributes such as price, availability, and ratings.

### Step 14

The server processes and filters the reservation options.
The server parses the raw API responses and converts them into internal offer objects. The server filters out offers that exceed the user's budget or conflict with user preferences (for example, wrong accommodation category) using conditional checks on data fields. The server may compute utility scores for each offer based on weighted combinations of price, rating, and distance, and sort the offers accordingly.
Input: raw reservation API responses and user constraints.
Output: a ranked and filtered list of reservation offers for transportation and accommodation.

### Step 15

The server optionally refines the offers using the generative AI model.
The server converts the filtered offer list into a textual description and constructs a new prompt sentence instructing the generative AI model to select or summarize the best options. For example, the prompt sentence can be:
“There are 8 hotel options with prices, ratings, and distances. The user prefers quiet hotels near the beach with high ratings and a medium budget. From these options, choose 3 and explain briefly why they are suitable.”
The server tokenizes this prompt, sends it to the generative AI model, and receives generated text identifying a subset of offers and rationales. The server then maps the generated descriptions back to concrete offer objects.
Input: filtered reservation offers and refinement prompt sentence.
Output: a smaller subset of recommended offers with associated explanations.

### Step 16

The server sends the curated plan options to the terminal.
The server formats the recommended offers, their prices, schedules, and textual explanations into a structured response and sends it to the terminal.
Input: curated subset of reservation offers.
Output: a network response containing concrete plan options delivered to the terminal.

### Step 17

The terminal displays plan options and acquires final plan selection.
The terminal presents each plan option as a detailed card with transportation schedule, accommodation details, total price, and explanation. The user selects one plan and confirms the intent to book, possibly agreeing to terms displayed on the screen.
Input: plan options from the server and user interactions.
Output: a final plan selection record with identifiers for chosen transport and accommodation offers and a confirmation flag.

### Step 18

The terminal transmits the final plan selection to the server.
The terminal embeds the final selection record, user identifier, and any required traveler details into a booking request and sends it to the server.
Input: final plan selection data.
Output: a booking request message delivered to the server.

### Step 19

The server creates reservations via external reservation APIs.
The server extracts the selected offer identifiers from the selection record and composes booking requests to the external reservation information processing devices. These requests include traveler details, payment reference information if required at booking, and all necessary parameters to confirm seats or rooms. The external systems return reservation result information such as reservation identifiers and confirmed itineraries.
Input: final plan selection record and external offer identifiers.
Output: reservation result information including identifiers and confirmed schedules.

### Step 20

The server stores reservation result information and initiates payment processing.
The server writes the reservation identifiers and details into its database, linking them to the user record. The server then calculates the total price for payment, including taxes and fees, by summing price components and, if necessary, converting currencies. The server constructs payment request data using the total amount and stored payment method tokens.
Input: reservation result information and pricing data.
Output: structured payment request data and persistent reservation records.

### Step 21

The server calls the payment processing service interface and records payment results.
The server sends the payment request data to a payment processing service application programming interface using secure communication. The payment service returns payment result information indicating success or failure and transaction identifiers. The server updates the corresponding reservation records with payment status and logs the transaction identifiers for later reference.
Input: payment request data.
Output: payment result information and updated reservation records with payment status.

### Step 22

The server notifies the terminal of reservation and payment completion.
The server prepares a confirmation message including travel destination, dates, transportation details, accommodation details, reservation identifiers, and payment status, and sends the message to the terminal.
Input: reservation records and payment result information.
Output: a confirmation response delivered to the terminal.

### Step 23

The terminal displays the final itinerary and confirmation details.
The terminal renders the complete itinerary and payment confirmation on the display, including reservation numbers, schedules, and key information for boarding or check-in. The user can review the details or store them using device functions.
Input: confirmation response from the server.
Output: visible itinerary and confirmation information presented to the user.

### Step 24

The server acquires weather information for the confirmed travel.
At a predetermined time before departure, the server uses travel destination and date information from the reservation records to construct queries for a weather information providing device. The server sends requests specifying location and date range and receives weather forecast data for the travel period.
Input: stored destination identifiers and travel dates.
Output: structured weather forecast information linked to the user's trip.

### Step 25

The server generates a description input prompt sentence for packing list generation.
The server converts the weather data, destination type, season, travel purpose, and previously computed emotional state into descriptive text. The server then constructs a prompt sentence instructing the generative AI model to output a packing list.
Example description prompt sentence:
“Destination: coastal resort, 7-day stay, two travelers.
Weather forecast: warm temperatures and occasional rain.
Travel purpose: relaxation and beach activities.
User emotional state: high stress, seeking comfort.
Generate a detailed packing list grouped by categories (Clothing, Toiletries, Electronics, Documents, Others) suitable for this trip.”
Input: weather forecast data, destination metadata, travel purpose, emotional state.
Output: a description input prompt sentence string for the generative AI model.

### Step 26

The server invokes the generative AI model to create a packing list.
The server tokenizes the description prompt sentence and submits the token sequence to the generative AI model. The model computes context-sensitive hidden states and outputs a list of textual items, each representing an article to bring.
Input: tokenized description input prompt sentence.
Output: generated text containing a packing list, formatted as sentences or bullet-style lines.

### Step 27

The server post-processes the packing list and prepares a notification payload.
The server parses the generated text, splits it into individual items, and assigns them to categories such as clothing or electronics based on keyword matching or simple heuristics. The server then bundles the categorized packing items together with the weather forecast into a notification data structure associated with the user's trip.
Input: generated packing list text and weather forecast data.
Output: a structured notification payload containing categorized packing items and weather information.

### Step 28

The server sends travel-day preparation information to the terminal.
The server transmits the notification payload to the terminal via a push notification service or via a pull mechanism when the terminal opens the travel application.
Input: notification payload from server memory or storage.
Output: a notification message delivered to the terminal.

### Step 29

The terminal displays the weather information and packing list and accepts further user refinements.
The terminal presents the weather forecast and categorized packing list to the user. The user may add, remove, or modify items or send additional natural language instructions, such as “I want to pack lighter” or “I need options for business meetings as well.”
Input: notification payload and user interactions.
Output: updated user instructions and optional modified packing preferences sent back to the server.

### Step 30

The server iteratively updates travel recommendations and packing lists based on additional condition inputs.
The server incorporates the new user instructions, re-runs sentiment analysis on the new text, and generates revised prompt sentences for either destination refinement or packing list adjustment. The server again invokes the generative AI model with the revised prompt sentences, obtains updated outputs, and sends the revised recommendations to the terminal.
Input: additional condition inputs and updated emotional state.
Output: updated travel destination candidates, plan options, or packing lists, thereby closing the loop of iterative refinement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented travel planning systems are typically configured as a set of loosely coupled services for recommendation, reservation, payment, and notification. In such systems, a server often treats each service as an isolated function: a static rule-based engine or simple scoring logic proposes destinations; a separate interface sends reservation requests; a separate module handles payments; and a further module obtains weather data. As a result, the server generally does not generate or adapt end-to-end travel plans based on a unified representation of user preferences, user emotional states, external context, and downstream service results. This fragmented architecture leads to several technical drawbacks in the operation of the computing system itself.

First, in conventional systems, the server tends to process user input information and past history information in an ad hoc, service-specific manner, without generating machine-interpretable feature representations that are consistently re-used across recommendation, reservation, and notification flows. For example, the server may store past trips in a relational database but may not convert such information into numerical feature vectors or structured context used as input to a generative AI model. Consequently, the server frequently performs redundant parsing and transformation operations, leading to increased processor load, inefficient memory usage, and latency spikes when multiple modules independently re-derive similar context from the same user data.

Second, typical systems that employ machine learning do not provide a systematic mechanism for constructing and dynamically adjusting prompt sentences for a generative AI model based on real-time context. Prompt sentences, when used, are often static templates that do not fully encode a user's historical data, numerical features, or emotional state. This causes the generative AI model to operate on incomplete or suboptimal context, which in turn reduces the precision of generated destination candidates and ancillary suggestions such as packing lists. From a computer-technology standpoint, this underutilizes the computational capability of the generative model and results in additional follow-up queries, retries, or manual corrections, thereby increasing network traffic, model execution time, and overall system resource consumption.

Third, conventional travel planning servers typically do not integrate emotion analysis engines into the core decision logic that governs how prompts are generated and how outputs from the generative AI model are post-processed. Even if emotion analysis is applied in a user interface layer, such analysis is not generally fed back into low-level prompt construction or selection algorithms at the server side. As a result, the server does not adapt its generative queries to the model in a way that accounts for user frustration, anxiety, or excitement. This lack of adaptation can cause extended interaction sequences, unnecessary re-generation of recommendations, and inefficient use of processing and network resources.

Fourth, many existing systems process contextual data such as weather prediction information and user attributes in separate pipelines that are not coherently combined into a single generative input for item suggestion tasks like packing list generation. A typical server might retrieve weather forecast data and then apply hand-coded rules to derive a simple list of items. Such rule-based processing leads to brittle behavior, requires frequent manual updates, and does not scale well across diverse destination types and user categories. The absence of a unified generative pipeline driven by systematically constructed prompt sentences contributes to code duplication, complex branching logic, and difficulty in maintaining and extending the system's behavior.

Fifth, current architectures often treat reservation results, payment results, and contextual recommendations (e.g., packing lists) as disjoint outputs delivered through different communication channels or at different times. The server may retrieve reservation confirmation from one API, payment status from another API, and weather information from a third API, and then present each piece of information in an uncoordinated manner. This fragmented presentation requires multiple state transitions in the server, additional database lookups, and repeated context reconstruction whenever the user resumes interaction. This increases the computational overhead at the server and complicates synchronization and error handling logic.

Accordingly, there is a need for a computer-implemented system and server-side technology that: (i) constructs prompt sentences for a generative AI model using unified user feature information, historical data, and external context; (ii) dynamically adjusts such prompt sentences and derived outputs based on emotion analysis results; (iii) integrates external reservation, payment, and weather information into a single generative and post-processing pipeline; and (iv) presents integrated outputs while persistently updating history information for reuse in subsequent generative queries. By solving these problems at the level of server architecture, data representation, and prompt construction, the invention aims to improve the operation of the computer system itself, reduce redundant computations and network calls, and enable more efficient and contextually appropriate generation of travel-related information.

The specific processing by the specific processing unit 290 of the data processing device 12 in Application Example 1 is realized by the following means.

The present invention provides a server comprising a processor and a storage device, the processor being configured to receive user input information from a user terminal, to acquire history information and preference information related to a user from the storage device based on the user input information and associated user identification information, to numericalize the history information and the preference information as feature quantities to generate user feature information, to generate a first prompt sentence that embeds the user feature information together with the user input information and that is to be input to a generative AI model, to input the first prompt sentence to the generative AI model to cause the generative AI model to generate structured movement destination candidate information, to rank the movement destination candidate information based on the structured output, to present the ranked movement destination candidate information to the user terminal and receive selected movement destination information from the user terminal, to execute reservation processing by communicating reservation condition information including the selected movement destination information, a movement period, a cost condition and a number-of-persons condition to an external reservation service via a communication interface to obtain reservation result information, to execute payment processing by communicating the reservation result information and user payment information to an external payment service via a communication interface to obtain payment result information, to obtain weather prediction information for the selected movement destination and the movement period from an external weather information service, to construct context information including the weather prediction information, the selected movement destination information, the movement period information and user attribute information, to generate a second prompt sentence that encodes the context information and a travel-purpose type and that is to be input to the generative AI model, to input the second prompt sentence to the generative AI model to obtain portable article candidate information, to post-process the portable article candidate information to generate portable article information by performing at least duplicate-item removal, classification assignment and display-format conversion, to analyze at least one of text information and sound information included in the user input information by using an emotion analysis engine to obtain an emotion analysis result, to dynamically adjust content of at least one of the first prompt sentence and the second prompt sentence based on the emotion analysis result so as to modify at least one of the movement destination candidate information and the portable article candidate information, and to present, in an integrated manner, the reservation result information, the payment result information, the weather prediction information and the portable article information to the user terminal and update the history information in the storage device based on the presented content for use in subsequent prompt generation for the generative AI model. This enables the computing system to perform end-to-end travel planning, reservation, payment, and context-aware notification through a unified generative pipeline that systematically constructs and dynamically adjusts prompt sentences based on numerical user feature information, external service results, and emotion analysis, thereby reducing redundant computations and network transactions, improving utilization of the generative AI model, and enhancing overall efficiency and robustness of server-side processing.

The term “user input information” refers to information entered or otherwise provided by a user via a user information processing terminal, including but not limited to text, voice, selection operations, and associated metadata such as timestamps and language indicators.

The term “user information processing terminal” refers to an endpoint computing device operated by a user, such as a smartphone, tablet, personal computer, or other electronic apparatus capable of communicating with a server over a network and presenting an interactive user interface.

The term “user identification information” refers to data that uniquely or pseudo-uniquely identifies a user in the system, including but not limited to user IDs, account IDs, device identifiers, or authentication tokens associated with the user.

The term “history information” refers to stored data representing past activity of a user, including but not limited to past travel records, previously selected destinations, prior reservations, and past interactions with the system.

The term “preference information” refers to stored data indicating tendencies, likes, dislikes, constraints, and other preference-related attributes of a user, such as preferred budget range, preferred climate, activity types, accommodation class, or travel style.

The term “storage device” refers to any memory or data storage subsystem accessible by the processor, including but not limited to semiconductor memory, magnetic storage, optical storage, or network-attached storage used to persistently or temporarily store data such as history information and preference information.

The term “user feature information” refers to numerical or structured feature data generated by transforming the history information and the preference information into machine-interpretable feature quantities suitable for processing by a generative AI model or other machine learning components.

The term “generative AI model” refers to a machine learning model configured to generate output data, such as text, structured data, or recommendations, based on input data including prompt sentences and feature representations, and implemented using techniques such as neural networks or other statistical learning architectures.

The term “prompt sentence” refers to textual or tokenized input data that encodes instructions, context, constraints, and user-related information, which is supplied to a generative AI model to control or guide the content and format of the model's generated output.

The term “first prompt sentence” refers to a specific prompt sentence constructed to obtain movement destination candidate information from a generative AI model, the first prompt sentence embedding at least user input information and user feature information.

The term “second prompt sentence” refers to a specific prompt sentence constructed to obtain portable article candidate information from a generative AI model, the second prompt sentence embedding at least weather prediction information, movement destination information, movement period information, and user attribute information.

The term “movement destination candidate information” refers to information generated by the generative AI model that represents one or more candidate travel destinations or locations suitable for a user, and may include identifiers, names, regions, and associated reasons or scores.

The term “movement destination information” refers to data representing a travel destination selected or fixed for a user, such as a geographic location, city, region, or area, including any identifiers, codes, or descriptive attributes corresponding to the selected destination.

The term “reservation condition information” refers to information specifying constraints and requirements for a reservation, including but not limited to movement destination information, movement period information, cost conditions, number-of-persons conditions, and accommodation or transportation preferences.

The term “movement period information” refers to data indicating a time period for travel, including start dates, end dates, durations, or other temporal parameters related to a planned trip.

The term “cost information” refers to data indicating monetary constraints or budget parameters associated with travel, including total budget, per-person budget, price limits, or preferred price ranges.

The term “number-of-persons information” refers to data indicating a count or composition of travelers associated with a reservation, such as number of adults, number of children, or total number of participants.

The term “external reservation service” refers to a remote reservation platform or system accessible via a communication interface and configured to provide search, availability, and booking functions for accommodations, transportation, or other travel-related resources.

The term “accommodation arrangement information” refers to reservation-related data for lodging facilities, including facility identifiers, room types, stay periods, pricing, and associated terms and conditions.

The term “movement arrangement information” refers to reservation-related data for transportation, including flight segments, train segments, ground transportation, routes, schedules, and associated pricing and conditions.

The term “reservation result information” refers to information returned from an external reservation service indicating a result of reservation processing, such as confirmation identifiers, booked items, terms, and status indicators.

The term “external payment service” refers to a remote payment processing system accessible via a communication interface and configured to perform payment authorization, capture, settlement, or related financial processing based on payment information.

The term “user payment information” refers to data necessary to perform a payment on behalf of a user, such as payment method tokens, account identifiers, billing information, or other credentials managed in accordance with applicable security standards.

The term “payment result information” refers to information returned from an external payment service indicating the outcome of a payment transaction, such as success or failure status, transaction identifiers, and receipt-related data.

The term “external weather information service” refers to a remote system or service that provides weather-related data, such as forecasts or meteorological observations, in response to queries specifying geographic locations and time periods.

The term “weather prediction information” refers to forecast data obtained from an external weather information service, including predicted conditions such as temperature, precipitation, wind, and weather patterns for specified locations and time periods.

The term “context information” refers to a structured aggregation of data used to condition generative processing, including at least weather prediction information, movement destination information, movement period information, user attribute information, and optionally travel-purpose information or other environmental factors.

The term “user attribute information” refers to data describing inherent or relatively stable characteristics of a user, such as age group, family composition, language, accessibility needs, or membership status.

The term “travel-purpose type” refers to information specifying a category or purpose of a trip, such as leisure, business, sightseeing, family travel, adventure travel, or other purpose classifications.

The term “portable article candidate information” refers to information generated by the generative AI model indicating candidate items to be carried or prepared by the user for a trip, such as clothing, accessories, devices, and travel essentials.

The term “portable article information” refers to processed information representing a finalized or refined list of recommended items for a trip, obtained by post-processing the portable article candidate information, and formatted for presentation, such as in list or checklist form.

The term “duplicate-item removal” refers to a post-processing operation in which items that are substantively identical or equivalent within the portable article candidate information are detected and removed or merged to avoid redundancy.

The term “classification assignment” refers to a post-processing operation in which items in the portable article candidate information are associated with one or more categories, such as clothing, toiletries, documents, electronics, or other functional groups.

The term “display-format conversion” refers to a transformation of data representation of one or more items from an internal or intermediate format into a presentation format suitable for display, such as bullet lists, checklists, tables, or grouped views.

The term “dialog response processing unit” refers to a functional component of the server configured to manage interactive message exchanges with a user information processing terminal, including formatting responses, maintaining conversational context, and presenting generated content to the user.

The term “emotion analysis engine” refers to a processing component or subsystem configured to analyze at least one of text information and sound information associated with user input to infer an emotional state of the user, such as satisfaction, frustration, anxiety, or excitement.

The term “emotion analysis result” refers to information generated by the emotion analysis engine that represents an inferred emotional state of a user, which may include categorical labels, scores, or other indicators of emotional conditions.

The term “communication interface” refers to hardware, software, or logical interfaces that enable data exchange between the server and external systems or services, using one or more communication protocols over a network.

The term “integrated presentation” refers to a manner of providing multiple types of information, such as reservation result information, payment result information, weather prediction information, and portable article information, in a combined or coordinated form to the user terminal, such that a user can view and utilize the information as a coherent set.

The term “subsequent prompt generation” refers to construction of one or more new prompt sentences for a generative AI model at a later time, the new prompt sentences being generated using updated history information or other updated context derived from prior interactions and outputs.

In one embodiment, a server cooperates with one or more terminals operated by users to implement the claimed system. The server includes at least one processor, a main memory, a non-volatile storage device, and one or more network interfaces. The server executes an operating system such as a general-purpose server operating system and application software including a web application framework, an API layer, a dialog response processing unit, a generative AI model execution unit, an emotion analysis engine interface, and external service integration modules. The server accesses a storage device that stores user history information, preference information, user feature information, model parameters, and log data. The terminals include portable information processing devices such as smartphones, tablet computers, or notebook computers, each executing a client application or web browser that provides a graphical user interface for dialog-based interaction with the server.

The server uses a relational database management system, such as a general-purpose structured query engine, to store user history information and preference information as normalized records. The server further uses an in-memory key-value store, such as a general caching layer, to cache frequently accessed user feature information and recent generative AI outputs. The server executes a runtime environment, such as a general-purpose script execution engine or a virtual machine, to run business logic modules that orchestrate data processing, prompt construction, and calls to machine learning libraries such as a tensor-based computation framework or an automatic differentiation framework.

The server uses a generative AI model that is implemented as a neural network, for example a transformer-based sequence-to-sequence model. The server configures the generative AI model with an encoder-decoder architecture comprising a plurality of layers, where each layer includes a multi-head self-attention mechanism, feed-forward sublayers, layer normalization units, and residual connections. The server stores model parameters, such as weight matrices and bias vectors, in the storage device and loads them into main memory for execution. The server defines an input embedding matrix that maps token identifiers to dense vector representations, positional encoding functions that encode token positions, and output projection matrices that map the final hidden states back to token probability distributions. The server uses a tokenizer library to convert prompt sentences into sequences of token identifiers. The server uses, for example, a byte-pair encoding tokenizer or a wordpiece tokenizer trained on travel-related corpora. The server defines a vocabulary that includes tokens for travel destinations, travel constraints, emotion descriptors, weather terms, and packing-related terms. The server embeds user feature information as additional numerical vectors concatenated to or added to the token embeddings, or as special tokens that encode feature values. The server thereby enables the generative AI model to process not only natural language text but also structured numerical features within a single forward pass. The server generates user feature information by transforming user history information and preference information into numerical vectors. The server applies feature extraction algorithms that map destination identifiers, travel durations, budget ranges, and activity categories to categorical and numerical features. The server encodes categorical features using one-hot encoding or learned embeddings and scales numerical features using normalization techniques, such as min-max scaling or z-score normalization. The server then concatenates these feature vectors to construct a user feature vector that is stored in the storage device and reused when generating prompt sentences.

The server implements the emotion analysis engine as a separate model or service. The server uses an acoustic feature extractor and a text classification model. The server analyzes text information by applying a recurrent neural network, a transformer encoder, or a convolutional neural network to tokenized user utterances, and computes probabilities over emotion classes such as positive, neutral, negative, anxious, or frustrated. The server analyzes sound information by extracting prosodic features such as pitch, intensity, and speech rate, and by applying a trained classifier to those features. The server outputs an emotion analysis result that includes an emotion label and confidence scores, and the server stores this result as part of the conversation context.

The server constructs a first prompt sentence for destination recommendation by combining user input information, user feature information, and system instructions. The server explicitly encodes constraints and output format requirements in the first prompt sentence. For example, the server uses a prompt sentence such as:
“Based on the user's past travel history and preferences described below, recommend 3 suitable travel destinations for a 5-day beach vacation in August with a total budget of 2000 USD. For each destination, output the destination name, country or region, and a short reason that reflects the user's preference for snorkeling and local food.”

The server embeds the user history information and preference information into the same prompt sentence, for example as:
“User past trips: beach resort A (7 days, snorkeling, local cuisine), island B (5 days, scuba diving). User budget preference: moderate. User climate preference: warm and sunny.”

The server then appends the instructions for the output, such as:
“Respond in plain text. List each destination on a separate line.”

The server also adjusts the first prompt sentence based on the emotion analysis result. For instance, if the user is detected as frustrated, the server modifies the first prompt sentence to include constraints such as “provide concise and clear explanations and avoid overly technical terms,” thereby guiding the generative AI model to produce more suitable output for the emotional state.

The server constructs a second prompt sentence for portable article recommendation by incorporating weather prediction information, movement destination information, movement period information, user attribute information, and travel-purpose type. The server uses a prompt sentence such as:
“Given that the user will travel to Honolulu from August 1 to August 6 for a leisure beach vacation, and that the forecast is hot, humid, and occasionally rainy, generate a detailed packing list of necessary items. Include clothing, footwear, sun protection, rain protection, and travel essentials. Provide the list as bullet points in plain text.”

The server includes user attribute information, for example:
“User attributes: traveling with two children, prefers outdoor activities, sensitive skin.”

The server embeds this context into the second prompt sentence to cause the generative AI model to generate portable article candidate information that takes into account specific user needs.

The server executes the generative AI model using specialized hardware such as general-purpose processors and, optionally, graphic processing units. The server computes attention matrices, multiplies them by value matrices, and applies nonlinear activation functions such as rectified linear units or gated linear units. The server computes a loss function during training, such as a cross-entropy loss between predicted token distributions and ground-truth token sequences, and updates the model parameters using gradient-based optimization algorithms such as stochastic gradient descent or adaptive moment estimation. The server may employ regularization techniques such as dropout, weight decay, and label smoothing during training to improve generalization.

The server performs inference by executing the model in a forward-only manner without weight updates. The server applies decoding strategies such as greedy decoding or beam search to transform token probability distributions into generated text sequences. The server sets parameters such as beam width, temperature, and top-k or top-p thresholds to control diversity and determinism of the generated outputs. The server can dynamically adjust these decoding parameters based on the emotion analysis result or complexity of the user request, which further improves generation quality and computation efficiency.

The server performs post-processing of generated movement destination candidate information and portable article candidate information. The server parses generated text using pattern matching, delimiters, or simple natural language parsing rules to identify destination names and reasons or item names. The server cross-references identified destinations against a database of supported destinations, converting textual names to canonical identifiers and discarding any invalid or unsupported destinations. The server sorts destinations according to relevance scores or explicit ranking constraints in the generated output. The server applies duplicate-item removal by comparing normalized strings of item names and by mapping synonyms to canonical item categories. The server performs classification assignment by mapping items to categories such as “clothing,” “toiletries,” “documents,” “electronics,” and “miscellaneous,” which are stored as structured fields in the storage device.

The server integrates external reservation services by communicating through a defined communication interface. The server constructs structured messages, such as HTTP requests with JSON payloads, that include movement destination identifiers, movement period information, number-of-persons information, and cost constraints. The server receives availability and pricing data from the external reservation service, parses the data, and selects optimal combinations according to algorithmic criteria such as cost minimization and schedule suitability. The server thereby reduces manual cross-checking and eliminates redundant search queries. By integrating the generative AI model output directly with the reservation selection algorithm, the server can narrow the search space for reservation candidates and decrease the number of network calls required to external services.

The server integrates external payment services by constructing secure payment requests that reference reservation result information and user payment information stored in a tokenized manner. The server sends payment requests via secure communication channels and records payment result information in the storage device. By linking payment status to reservation result information and user history information, the server generates a stable data structure that can be used to resume interrupted sessions and avoid duplicate charges. This integration contributes to reliable transaction handling and reduces the likelihood of inconsistent states in the system.

The server integrates external weather information services by constructing queries containing movement destination coordinates or codes and movement period information. The server receives weather prediction information composed of structured forecast data. The server summarizes this data into features such as minimum and maximum temperatures, precipitation probabilities, and weather condition categories. The server uses these features as elements of context information for the second prompt sentence. This approach allows the generative AI model to condition its output on quantitative forecasts rather than static seasonal assumptions, thus improving the relevancy of the portable article candidate information.

The server maintains a dialog response processing unit that manages sessions with terminals. The server stores a conversation state object for each user, including the last generated movement destination candidate information, last portable article information, emotion analysis results, and any unresolved reservations. The server thus avoids repeatedly requesting the same context from external services and avoids recomputing user feature information for each message. This stateful design reduces redundant computations and network usage, improving response time and server throughput.

The server updates history information when a travel plan is confirmed or modified. The server records destination identifiers, travel dates, budgets, selected activities, and used packing lists in the storage device. The server recalculates user feature information periodically or upon significant changes. The server uses incremental update algorithms that modify only the affected components of the user feature vector rather than recomputing the entire vector, which reduces computational cost.

The server achieves technical improvements over conventional systems in several ways. By representing user history information and preference information as numerical feature vectors and embedding these vectors directly into prompt sentences or into model input tensors, the server reduces repeated parsing and ad hoc data manipulation. This leads to improved cache locality and reduced memory copying. By centralizing prompt construction and dynamic adjustment based on emotion analysis results and external context, the server reduces the number of generative model invocations and network round trips necessary to converge on suitable recommendations, thereby decreasing latency and network traffic.

The server further improves computational efficiency by coupling generation tasks (destination recommendation and packing list generation) with structured post-processing and caching. For example, the server reuses the same user feature information and emotion analysis result across multiple steps of a session, thus avoiding repeated feature extraction runs. The server can also cache popular combinations of destinations, weather patterns, and packing lists, and only invoke the generative AI model when new or unusual combinations arise.

The server uses non-conventional ordering and integration of processing components. Rather than first computing all data via separate pipelines and then joining results, the server constructs prompt sentences that encode constraints, external data, and emotion results as a single context and obtains structured outputs in one model pass. The server then performs lightweight post-processing. This contrasts with typical rule-based or pipeline architectures and results in fewer intermediate data structures, simplified error handling, and improved maintainability.

The terminal interacts with the server by sending user input information and receiving responses. The terminal executes a client application that displays dialog messages, recommended destinations, reservation status, payment results, weather summaries, and packing lists. The terminal may store only transient user interface state, while persistent data and heavy computation remain on the server. The terminal may provide microphone and camera inputs for capturing voice or other modalities for use by the emotion analysis engine.

The user operates the terminal to input preferences, review options, and confirm selections. The user benefits from the system's ability to produce highly tailored and technically consistent outputs that integrate destination recommendations, reservations, payments, weather predictions, and packing suggestions. However, the technical advantage resides at the server side, where the claimed configuration improves computer performance by using structured feature representations, integrated prompt construction, and dynamic model configuration based on emotion analysis.

In alternative embodiments, the server may use different types of generative AI models, such as encoder-only language models or decoder-only language models, and may adjust the neural network depth, number of attention heads, and hidden layer sizes to meet performance and accuracy requirements. The server may employ different optimization algorithms or regularization methods during training. The server may deploy multiple generative AI models specialized for different tasks (e.g., one for destination recommendation and another for packing list generation), where each model is invoked with task-specific prompt sentences and feature embeddings. The server may further adapt the architecture to distributed computing environments, where different modules run on separate servers and communicate through message queues or microservice interfaces.

In other embodiments, the server may integrate additional contextual data sources, such as transportation delays, public event schedules, or health advisories, by extending the context information and constructing corresponding prompt sentences. The server may also refine emotion analysis to include more granular categories or continuous affective dimensions. The server can then adjust model decoding parameters, such as temperature and beam width, or alter the verbosity and specificity of generated text in response to the detected emotional state, further enhancing the technical behavior of the generative AI model and reducing unnecessary regeneration cycles.

In all embodiments, the server uses explicit data structures, specific machine learning architectures, and defined prompt construction and adjustment rules to accomplish technical improvements in processing speed, resource utilization, data consistency, and output quality. The system thus provides more than mere automation of human travel planning; instead, the system improves the functioning of the computer itself by reorganizing how user data, model inputs, and external service outputs are represented, combined, and processed in the server.

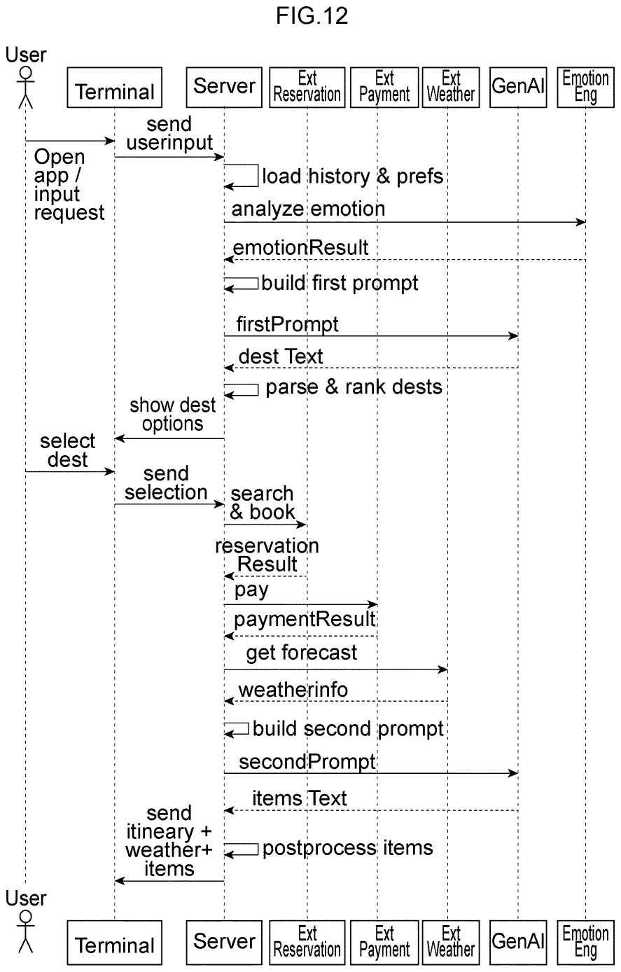

The following describes the processing flow using FIG. 12.

### Step 1

The user operates the terminal to launch a client application or web browser and opens a travel planning chat screen.
The terminal receives text or voice input from the user, such as “I want to go to a beach resort for 5 days in August with a budget of 2000 USD,” and converts the input into a structured message including user input information and user identification information.
The terminal sets the structured message as input, serializes it into a request payload, and sends the request to the server over a network using a secure communication protocol.
The output of this step is a network message that contains the user input information and the user identification information delivered to the server.

### Step 2

The server receives the network message from the terminal via a communication interface and parses the message to extract user input information and user identification information.
The server sets the parsed data as input and performs validation operations, such as checking that required fields are present, confirming that date strings have valid formats, and verifying that numeric values like budget are within allowable ranges.
The server then queries a storage device using the user identification information as a key, and retrieves corresponding history information and preference information.
The output of this step is a validated set of user input information combined with associated history information and preference information in a structured internal representation.

### Step 3

The server sets the history information and preference information as input and generates user feature information by transforming these data into numerical feature vectors.
The server applies data processing operations such as one-hot encoding of categorical variables (e.g., destination categories), embedding lookups for frequent destinations, and normalization of numerical values (e.g., budget amounts and trip durations).
The server concatenates and stores the resulting vectors as user feature information in the storage device and also prepares them in memory for immediate use.
The output of this step is user feature information expressed as one or more numerical vectors suitable for input to a generative AI model.

### Step 4

The server sets the user input information, the history information, the preference information, and the user feature information as input and constructs a first prompt sentence for a generative AI model.
The server assembles instruction text, such as “You are a travel recommendation assistant,” followed by contextual text describing past trips and preferences, and constraint text describing current requirements (destination type, period, budget).
The server then appends explicit output format instructions, such as “Recommend three destinations and provide a brief reason for each, one per line.”
The output of this step is a first prompt sentence in natural language that encodes both user context and generation constraints for the generative AI model.

### Step 5

The server sets at least one of text information and sound information included in the user input information as input to an emotion analysis engine.
The server tokenizes text input and extracts acoustic features from sound input, then applies an emotion classification model to compute probabilities for different emotion categories.
The server determines an emotion analysis result by selecting a dominant emotion label and associated confidence scores, and stores this result as part of the current session context.
The output of this step is an emotion analysis result that characterizes the user's emotional state.

### Step 6

The server sets the first prompt sentence and the emotion analysis result as input and adjusts the content of the first prompt sentence according to the emotional state.
The server performs text editing operations, such as adding sentences instructing the generative AI model to be more concise or more detailed, modifying the tone (e.g., “provide reassuring explanations” for anxious users), or changing the number of recommended destinations.
The server thereby generates an adjusted first prompt sentence that is tailored to the detected emotional state.
The output of this step is a finalized first prompt sentence ready for input to the generative AI model.

### Step 7

The server sets the finalized first prompt sentence and, optionally, the user feature information as input to the generative AI model.
The server uses a tokenizer to convert the prompt sentence into a sequence of token identifiers and constructs model input tensors that include embedded token vectors and, if used, appended user feature vectors.
The server executes the generative AI model by performing a forward pass through neural network layers, computing attention scores, hidden states, and output token probability distributions.
The server decodes the output token probabilities using a decoding algorithm, such as greedy decoding or beam search, to generate a text response describing movement destination candidate information.
The output of this step is generated text that contains one or more candidate destinations and associated explanatory text.

### Step 8

The server sets the generated text as input and performs parsing to extract structured movement destination candidate information.
The server analyzes line breaks, separators, and key phrases to identify destination names, countries or regions, and reasons, and maps each recognized destination name to an internal destination identifier using a lookup table in the storage device.
The server filters out destinations that are not supported or are invalid, and then ranks the remaining candidates based on scores implied by the generative AI model output or predefined ranking rules.
The output of this step is a structured list of movement destination candidate information, each entry containing at least a destination identifier, a display name, and a reason.

### Step 9

The server sets the structured list of movement destination candidate information as input and generates a response message for the terminal via the dialog response processing unit.
The server formats the list into a natural language message and attaches metadata that allows the terminal to render selectable options (e.g., buttons or list items).
The server transmits this response message to the terminal over the network.
The output of this step is a network response containing formatted movement destination candidate information ready for user selection.

### Step 10

The terminal receives the response from the server and parses the message to obtain the movement destination candidate information.
The terminal presents the candidate destinations to the user in a graphical user interface, for example as a list of cards or buttons showing destination names and reasons.
The user reviews the options and selects one destination using an input device such as a touch screen or pointing device.
The terminal sets the user's selection as input, encapsulates it as movement destination information along with movement period information, cost information, and number-of-persons information if already specified, and sends this selection to the server.
The output of this step is a new network message delivered to the server that includes the selected movement destination information and related reservation condition information.

### Step 11

The server receives the selected movement destination information and reservation condition information as input and prepares a request to an external reservation service.
The server converts the selected destination identifier to a format required by the external service, such as a location code, and combines it with movement period information, number-of-persons information, and cost constraints into a structured reservation query.
The server sends this query via a communication interface to the external reservation service and receives availability and pricing data in response.
The output of this step is a set of accommodation arrangement information and movement arrangement information obtained from the external reservation service.

### Step 12

The server sets the accommodation arrangement information and movement arrangement information as input and selects optimal combinations according to predefined algorithms.
The server evaluates each candidate combination by computing metrics such as total cost, travel time, and rating scores, and may assign weights to these metrics to compute a composite score for each combination.
The server chooses one or more combinations with the highest composite score and then initiates reservation processing by sending booking requests back to the external reservation service.
The server receives confirmation messages and extracts reservation result information such as booking identifiers and terms.
The output of this step is finalized reservation result information stored in the storage device and associated with the user.

### Step 13

The server sets the reservation result information and user payment information as input and constructs a payment request for an external payment service.
The server includes identifiers of reserved items, total payment amount, currency, and a token or identifier representing the user's payment method, and sends this request over a secure channel to the external payment service.
The server receives a payment response that includes payment result information such as transaction status, transaction identifiers, and receipt information.
The server stores this payment result information in the storage device and updates the reservation status according to the payment outcome.
The output of this step is payment result information linked to the corresponding reservation result information.

### Step 14

The server sets the selected movement destination information and the movement period information as input and constructs a weather query for an external weather information service.
The server converts the movement destination information into geographic coordinates or a standardized location code and includes the movement period information to specify the date range of interest.
The server sends the weather query and receives weather prediction information composed of daily or hourly forecast data, such as temperatures, precipitation probabilities, and weather condition codes.
The server stores the weather prediction information in the storage device for use in subsequent processing.
The output of this step is structured weather prediction information associated with the user's planned trip.

### Step 15

The server sets the weather prediction information, the selected movement destination information, the movement period information, user attribute information, and travel-purpose type as input and constructs a second prompt sentence for portable article recommendation.
The server composes text describing the destination, dates, and forecast, and adds explicit instructions such as “generate a detailed packing list” and “include clothing, accessories, and travel essentials.”
The server incorporates user attributes, for example indicating the presence of children or special health considerations, into the second prompt sentence.
The output of this step is a second prompt sentence that encodes context information and constraints for the generative AI model.

### Step 16

The server sets the second prompt sentence and, optionally, user feature information as input to the generative AI model.
The server tokenizes the second prompt sentence, embeds the tokens, and feeds the embeddings through the same or a different neural network architecture to compute output token probabilities representing portable article candidate information.
The server decodes the probabilities into a text list of items, such as “sunscreen, swimsuit, sandals, light clothing, hat, light rain jacket,” using a decoding algorithm configured for list generation.
The output of this step is generated text that contains portable article candidate information.

### Step 17

The server sets the generated portable article candidate information as input and performs post-processing operations.
The server splits the text into individual item names, normalizes the text by lowercasing and trimming whitespace, and removes duplicates by comparing normalized strings or mapped canonical item identifiers.
The server assigns each item to at least one category, such as clothing or toiletries, using a predefined item-classification table, and then formats the items into a checklist representation suitable for display.
The output of this step is portable article information in a structured format that includes categorized items without redundancy.

### Step 18

The server sets the reservation result information, the payment result information, the weather prediction information, and the portable article information as input and generates an integrated response message.
The server arranges these pieces of information into a coherent structure, such as itinerary details followed by payment confirmation, weather summary, and packing checklist, and then converts this structure into a message suitable for presentation by the dialog response processing unit.
The server sends the integrated response to the terminal over the network and updates history information in the storage device to include the newly confirmed trip and associated data.
The output of this step is an integrated communication to the terminal that presents all relevant travel information and an updated history information record usable in subsequent prompt generation.

### Step 19

The terminal receives the integrated response from the server and parses the message to obtain the reservation result information, payment result information, weather prediction information, and portable article information.
The terminal displays an itinerary screen summarizing bookings and payments, a weather panel showing forecast details, and a checklist interface listing recommended portable articles with selectable checkboxes.
The user views this information, confirms the trip details, and optionally interacts with the packing checklist by marking items as prepared.
The output of this step is an updated user interface state on the terminal that reflects the completed planning, reservation, and preparation support provided by the system.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional travel support systems generally separate (i) destination recommendation, (ii) reservation and payment processing, and (iii) travel preparation support such as packing advice, into independent and loosely coupled functions. In many cases, a server merely applies static business rules or simple filtering to user profile data and travel history to propose destinations, and then relies on separate rule-based engines or fixed templates to generate packing suggestions. Such arrangements exhibit multiple technical shortcomings when implemented on computer systems.

First, because conventional systems do not systematically integrate heterogeneous data sources-including structured reservation data, real-time weather data, and user-specific context such as travel purpose-into a unified machine-processable representation, the server must perform multiple separate data retrievals and transformations. This leads to redundant processing, inefficient use of processing resources, and increased network traffic between server components and external services. The lack of a unified representation also makes it difficult to consistently reuse previously acquired information across different stages of the travel workflow, resulting in repeated calls to external application programming interfaces and duplicated parsing logic.

Second, existing systems that employ generative artificial intelligence often treat such models as isolated “black-box” components, to which unstructured and manually crafted queries are sent. Without a structured prompt generation mechanism that programmatically converts machine-readable context (for example, user history records, reservation records, and weather records) into a controlled natural-language prompt sentence, the server cannot reliably control the behavior of the generative AI model. This frequently results in non-deterministic outputs, inconsistent data formats, and the need for extensive manual post-processing and correction on the server side, which degrade overall system performance and reliability.

Third, typical travel support systems do not incorporate user emotional state as a first-class signal in the computational workflow. If sentiment or emotion is considered at all, it is usually handled by a separate analytic module producing results that are not directly integrated into the algorithms for destination ranking or packing list generation. Consequently, the server cannot adapt the behavior of its computational pipeline in response to the user's emotional state, and cannot automatically tune the generative AI model prompts to reflect stress, anxiety, excitement, or other relevant emotional conditions. This limitation reduces the effectiveness of the system as a personalized decision-support tool.

Fourth, conventional packing list generation is often hardcoded or uses static templates that are not robust to varying weather, travel duration, or complex user constraints. When these systems attempt to adopt generative AI models, they typically do not require the model to output structured data with explicit categorization and explanation fields. As a result, the server must perform complex and error-prone text parsing to extract item names and categories from free-form text, which leads to increased processing time, higher failure rates, and difficulty in presenting the results as interactive, machine-readable checklists at the user terminal.

Accordingly, there is a need for an improved computer-based system and server-side processing architecture that: (i) unifies travel-related information, weather information, and user-related context into a consistent internal representation; (ii) automatically generates context-aware prompt sentences to control a generative AI model for both destination recommendation and packing list generation; (iii) integrates emotion analysis results into the computational pipeline; and (iv) enforces structured output formats for AI-generated lists. Such a system should improve the efficiency, robustness, and adaptability of the travel support workflow as executed by the server, thereby improving the overall operation of the computer system itself rather than merely automating a human mental process.

The specific processing by the specific processing unit 290 of the data processing device 12 in Example 2 is realized by the following means.

The present invention provides a server comprising a processor, a storage device configured to store user-related information including travel history information and preference information, and a communication interface configured to communicate with at least one external information processing apparatus, at least one external payment processing apparatus, at least one external weather information providing apparatus, at least one external generative AI model, and at least one user terminal, wherein the processor is configured to execute a sequence of machine-implemented operations that unify and leverage heterogeneous travel-related data in a controlled interaction with the generative AI model. This enables the server to improve computer-based travel support processing by (i) reducing redundant data retrieval and rule evaluation, (ii) programmatically generating and controlling prompt sentences to obtain structured outputs from the generative AI model, and (iii) adaptively adjusting destination proposals and packing list generation based on user emotional state.

In one aspect, the processor is configured to acquire, from the storage device, user-related information including the travel history information and the preference information of a user, to compute destination candidates based on the acquired user-related information, and to perform a destination proposal process for the user based on the computed destination candidates. The processor is further configured to automatically generate, based on an analysis of the user-related information, a first prompt sentence that instructs the generative AI model to generate destination candidates, to input the first prompt sentence into the generative AI model via the communication interface, and to receive, as output, machine-generated destination candidates in a predetermined format. By performing these operations, the processor reduces the need for fixed rule sets and leverages the generative AI model under programmatic control through the automatically generated prompt sentence.

In another aspect, the processor is configured to execute, based on a destination and schedule information selected by the user from among the destination candidates, a reservation process for an accommodation facility and a transportation facility by using a reservation function of an external reservation system via the external information processing apparatus, and to acquire reservation information as a result of the reservation process. The processor is further configured to execute, based on the acquired reservation information, an electronic payment process by using a payment function of the external payment processing apparatus, and to acquire payment completion information as a result of the electronic payment process. By integrating reservation and payment processing into the same server-side workflow that manages the generative AI model interaction, the invention enables the server to maintain a consistent internal representation of trip context to be reused in subsequent computations. In a further aspect, the processor is configured to acquire, based on location information and schedule information included in the reservation information, weather information for a travel destination from the external weather information providing apparatus, and to integrate the acquired weather information, the user-related information, and travel condition information to generate context information describing at least weather conditions, season, and travel purpose. The processor is configured to automatically generate, based on the context information, a second prompt sentence that instructs the generative AI model to generate a packing list optimized for the described context, and to input the second prompt sentence into the generative AI model. The processor receives, from the generative AI model, a packing list in a structured format, and generates the packing list as structured data including classification information indicating categories of items and explanation information indicating reasons for each item. The processor then transmits the structured data to the user terminal so as to notify the packing list to the user. By automatically constructing the second prompt sentence from machine-readable context information and by enforcing a structured output format, the processor reduces post-processing burden and improves the reliability of the AI-generated packing list as machine-usable data.

In an additional aspect, the processor is configured to analyze an emotional state of the user by using an emotion analysis engine based on input information received from the user via the user terminal, and to reflect an analysis result of the emotional state in at least one of the computation of the destination candidates and the generation of the packing list. For example, the processor may adjust weighting parameters used for destination scoring or modify the content of the first and second prompt sentences to emphasize relaxing destinations or to include specific comfort items in the packing list when the user is detected to be anxious or stressed. This integration of emotional state analysis into the computational pipeline provides an adaptive control layer that changes the behavior of the server's algorithms, thereby improving personalization while remaining a purely technical modification in the way the processor allocates and uses resources.

Taken together, these means implement a server-centric architecture in which the processor: (i) acquires and normalizes user-related and trip-related data, including weather information; (ii) generates and manages context-dependent prompt sentences for a generative AI model for both destination generation and packing list generation; (iii) requires the generative AI model to output structured data amenable to direct consumption by downstream processes; and (iv) incorporates emotion analysis results into the computational flow. As a result, the invention improves the functioning of the computer system by reducing redundant data processing, enhancing control over generative AI model behavior, and enabling more efficient and reliable generation of travel-related recommendations and packing lists.

The term “server” refers to an information processing apparatus including at least one processor, a storage device, and a communication interface, configured to execute programmed instructions to provide travel support functions to one or more user terminals over a communication network.

The term “processor” refers to a hardware element, such as a central processing unit or a processing core, capable of executing computer-readable instructions to perform arithmetic, logic, data movement, and control operations that implement the described functions of the server.

The term “storage device” refers to any non-transitory computer-readable medium, including a memory or a secondary storage unit, configured to store user-related information, travel-related information, program code, and intermediate data used by the processor.

The term “communication interface” refers to a hardware and software combination that enables the server to exchange data with external apparatuses and user terminals via a wired or wireless communication network.

The term “user-related information” refers to information associated with a particular user, including but not limited to travel history information, preference information, demographic information, and input information received from the user.

The term “travel history information” refers to information indicating past travel activities of a user, including destinations, dates, types of trips, evaluations, and other records associated with previously executed travel.

The term “preference information” refers to information indicating likes, dislikes, and tendencies of a user, including preferred types of destinations, budget ranges, accommodation types, transportation types, and other user-specific preferences.

The term “destination candidate” refers to a possible travel destination identified by the server as suitable for a user based on user-related information, and used in a destination proposal process.

The term “destination proposal process” refers to a sequence of operations in which the processor computes destination candidates, obtains additional information if necessary, and presents one or more recommended destinations to the user via a user terminal.

The term “external information processing apparatus” refers to an apparatus or service, separate from the server, that provides information processing functions such as reservation processing through an application programming interface.

The term “external payment processing apparatus” refers to an apparatus or service, separate from the server, that performs electronic payment processing including authorization and settlement of payment transactions.

The term “external weather information providing apparatus” refers to an apparatus or service, separate from the server, that provides weather information for a given location and time via a communication interface.

The term “external reservation system” refers to a system, accessible via the external information processing apparatus, that manages reservation data and executes reservation processing for facilities such as accommodations and transportation.

The term “reservation information” refers to information indicating a result of reservation processing, including identifiers of reserved services, dates, locations, prices, and status of the reservations.

The term “electronic payment process” refers to processing in which the server, via the external payment processing apparatus, performs electronic payment for a reservation, including at least one of authorization, capture, and confirmation operations.

The term “payment completion information” refers to information indicating that an electronic payment process has successfully completed, including transaction identifiers, timestamps, and payment status values.

The term “location information” refers to information specifying a geographic position, including but not limited to a country, city, address, coordinate values, or other identifiers of a travel destination.

The term “schedule information” refers to information indicating dates and times related to a travel of a user, including departure dates, arrival dates, durations of stay, and time ranges associated with the trip.

The term “weather information” refers to information indicating meteorological conditions at a given place and time, including but not limited to temperature, precipitation, wind, humidity, and textual descriptions of weather conditions.

The term “travel condition information” refers to information describing conditions under which a user will travel, including at least one of weather information, season, travel purpose, travel duration, number of travelers, and planned activities.

The term “context information” refers to combined information generated by the processor by integrating location information, schedule information, weather information, travel purpose information, and optionally other user-related information, and used as a basis for generating a prompt sentence.

The term “travel purpose information” refers to information indicating a primary purpose of a trip, including but not limited to leisure, business, family visit, or event participation.

The term “generative AI model” refers to a machine learning model, such as a large language model, configured to generate output data including natural language sentences or structured lists in response to an input prompt sentence.

The term “prompt sentence” refers to a text string provided as input to the generative AI model, the text string including instructions or context that cause the generative AI model to generate a desired type of output.

The term “packing list” refers to a set of item entries representing objects that a user is recommended to bring on a trip, each item entry optionally including category information and explanation information.

The term “structured data” refers to data arranged in a predefined format, such as a list, table, or hierarchical structure, in which fields and relationships among fields are explicitly specified and machine-readable.

The term “classification information” refers to information indicating a category or type associated with an item in the packing list, such as clothing, footwear, accessories, electronic devices, documents, or health-related items.

The term “explanation information” refers to information providing a reason or description associated with an item in the packing list, indicating why the item is recommended or how it is to be used.

The term “user terminal” refers to an electronic apparatus operated by a user, such as a mobile communication device, a tablet, or a personal computer, configured to communicate with the server and to present information to the user and receive input from the user.

The term “emotion analysis engine” refers to a software module or service configured to analyze user input information, such as text or voice, and to output an estimated emotional state of the user.

The term “emotional state” refers to an internal status of a user, estimated by the emotion analysis engine, including but not limited to states such as stress, anxiety, relaxation, excitement, satisfaction, or dissatisfaction.

The term “analysis result of the emotional state” refers to information output from the emotion analysis engine that represents the estimated emotional state, and that is used by the processor to modify at least one of destination candidate computation and packing list generation.

The term “user input information” refers to data provided by the user to the system via the user terminal, including but not limited to text messages, responses to questions, feedback, and other interaction data.

The term “application programming interface” refers to an interface specification and associated mechanisms that enable software components to request services and exchange data with external systems over a communication network.

The term “communication network” refers to any wired or wireless network that enables data exchange between the server, external apparatuses, and user terminals, including at least one of a local area network and a wide area network.

The term “machine-implemented operation” refers to an operation executed automatically by hardware and software of the server without requiring manual execution of the underlying algorithmic steps by a human.

In one embodiment, a server implements the claimed system as a network-accessible travel support platform. The server includes at least one processor, a main memory (for example, dynamic random-access memory), a non-transitory storage device (for example, a magnetic disk, a solid-state drive, or a storage array), and a communication interface (for example, a network interface controller supporting a packet-based protocol). The server executes an operating system such as a generic server operating system and an application stack implemented, for example, in a programming language such as Python or Java running on an application framework such as a web service framework.

The server stores, in the storage device, user-related information including travel history information and preference information. The server manages this information in a structured data repository, such as a relational database management system. The server defines, in the database, a plurality of tables or collections, including at least a user table, a travel_history table, a preference table, a reservation table, a weather_info table, a packing_list table, and a prompt_log table. Each table is indexed on relevant keys (for example, user identifier, reservation identifier, timestamp) so that the processor can perform high-speed retrieval operations.

The server configures the communication interface to communicate with at least one external information processing apparatus, at least one external payment processing apparatus, at least one external weather information providing apparatus, at least one external generative AI model, and at least one user terminal, through a packet-switched communication network such as the Internet. The server exposes one or more application programming interfaces to the user terminal, and the server uses client libraries or generic HTTP protocols to communicate with the external apparatuses.

The terminal operates as a client device such as a smartphone, tablet, or personal computer. The terminal executes a client application that communicates with the server via the communication network. The terminal displays, on a graphical user interface, destination proposals, reservation information, and packing lists transmitted from the server. The terminal acquires user inputs, including user identifiers, destination selections, date selections, and free-text comments, and transmits structured representations of those inputs to the server. The terminal can be implemented, for example, as a mobile application running on a generic mobile operating system using standard user interface widgets.

The user operates the terminal to register profile information and to perform travel-related operations. The user inputs preferences, such as preferred climate, accommodation type, and budget range, and the user provides feedback on past trips. The user may also input natural language text representing concerns, expectations, or questions, which the server uses as part of emotion analysis.

The server stores a generative AI model as a remote or local model resource. In one embodiment, the generative AI model is a large language model implementing a transformer-based neural network architecture. The generative AI model includes an embedding layer configured to map tokenized input words of a prompt sentence into dense vector representations, a plurality of self-attention layers configured to compute contextualized representations using multi-head attention mechanisms, and a feed-forward layer configured to transform intermediate representations into output logits over a vocabulary. The generative AI model has parameters (weights) that have been trained using a sequence modeling objective such as next-token prediction on a large corpus of text data.

The server configures the generative AI model to run on dedicated computation hardware such as a graphics processing unit or a tensor processing unit. The server supplies to the generative AI model, via a model interface, input prompt sentences encoded into token sequences, and the generative AI model outputs generated token sequences that the server decodes into natural language text. In one embodiment, the server executes the generative AI model through a model serving layer, and the server sets model parameters such as temperature, maximum token length, and nucleus sampling threshold to control the diversity and determinism of the output. The server uses predetermined decoding strategies (for example, beam search or nucleus sampling) to balance the variety and stability of generated text.

The server further incorporates an emotion analysis engine. In one embodiment, the emotion analysis engine is implemented as a separate neural network model such as a bidirectional recurrent neural network or a transformer classifier trained on labeled sentiment or emotion corpora. The server uses the emotion analysis engine to classify user input texts into a plurality of emotion labels, such as “stressed,” “anxious,” “relaxed,” or “excited,” and to assign a confidence score to each label. The server stores the emotion analysis results in association with the user identifier and timestamps.

The server executes a recommendation module that uses machine learning to compute destination candidates. In one embodiment, the recommendation module uses a matrix factorization model or a feed-forward neural network that takes as input user features and destination features. The user features include numerical encodings of user preferences, aggregate statistics derived from travel history (for example, average trip length, distribution of visited climate zones), and latent factors learned during model training. The destination features include geographic attributes, typical climate, cost ranges, and category encodings. The recommendation module has been trained offline using historical user-destination interaction data with a loss function such as mean squared error or cross-entropy, and the server updates model weights via gradient descent during training.

The server performs data preprocessing on the storage device before supplying data to the recommendation module. The server encodes categorical variables into numerical identifiers, normalizes numerical fields, and assembles feature vectors into fixed-length arrays. By transforming high-level records into compact feature vectors, the server reduces memory footprint and improves cache locality when executing matrix operations, thereby improving computation speed.

The server uses the recommendation module to compute numerical scores representing suitability of candidate destinations for the user. The server sorts candidate destinations according to these scores and selects a subset as destination candidates. The server then uses the generative AI model not to compute the scores directly but to generate natural language descriptions or enriched proposals. To this end, the server generates a first prompt sentence based on structured user-related information and the computed candidates.

In one example, the server generates the following prompt sentence as text:
“The user has previously traveled to warm seaside locations and highly rated trips involving outdoor leisure activities. The user prefers mid-range accommodation and moderate budgets. Based on this profile, here are several candidate destinations: Destination A (subtropical beach), Destination B (island resort), Destination C (coastal city). Please summarize the key characteristics of each candidate destination, and suggest which destination may be most suitable for a 4-day leisure trip starting next month. Explain the reasoning in concise bullet points.”

The server constructs this prompt sentence using a template mechanism. The server assembles a data structure that stores factors such as preferred climate, budget range, and typical trip length. The server fills placeholders in the template with actual values from the user's data. This controlled construction ensures that the generative AI model receives a deterministic and structured context. As a result, the server reduces variability in AI outputs and thereby reduces downstream post-processing complexity.

The server executes a reservation module that communicates with the external information processing apparatus. The server constructs structured requests that include the chosen destination, dates, and traveler counts, and the server transmits these requests to the external reservation system using a defined application programming interface. The server receives responses including available accommodation and transportation options. The server converts these responses into normalized reservation information records stored in the reservation table.

The server then interacts with the external payment processing apparatus. The server obtains payment tokens or authorization data from the terminal and transmits structured payment requests to the external payment processing apparatus. The external payment processing apparatus returns payment completion information. The server associates payment completion information with reservation information in the storage device. This coordinated handling of reservation and payment flows allows the server to maintain a consistent trip context object, which is later re-used when constructing prompt sentences for the generative AI model.

The server acquires weather information by communicating with the external weather information providing apparatus. The server supplies location information and schedule information extracted from reservation information and receives, in response, weather forecasts for dates corresponding to the trip. The server parses weather data such as temperature range, precipitation probability, and weather conditions (for example, “heavy rain,” “snow,” “clear sky”) and stores normalized values in the weather_info table. The server reduces redundant external calls by caching weather data per location and time interval and by associating the cached data with multiple reservations when appropriate, thereby reducing network traffic and improving computation efficiency.

The server integrates user-related information, travel condition information, and weather information into context information for packing list generation. The server investigates, for example, the trip duration, average expected temperature, precipitation pattern, travel purpose, number of travelers, and the emotional state of the user. The server encodes this context into a compact representation that includes both machine-readable fields and human-readable summaries. The server then constructs a second prompt sentence for the generative AI model.

In one example, the server constructs the following prompt sentence:
“The user is going on a 4-day leisure trip to a subtropical island next week. The forecast at the destination is heavy rain with temperatures between 23 and 26 degrees Celsius and strong wind. The user plans to spend a lot of time walking outdoors for sightseeing. The user is currently feeling somewhat anxious about forgetting important items. Please generate a detailed packing list that is optimized for this weather and travel style. Group items into categories (clothing, footwear, rain gear, accessories, electronic devices, documents, health items, comfort items). For each item, provide a short explanation of why it is necessary or useful. Please output the list in clear bullet points with category headings.”

The server, in another example, constructs a prompt sentence for a cold-weather trip:
“The user is traveling to a cold snowy city for 5 days in January for leisure. The expected temperature ranges from −5 to 0 degrees Celsius, with frequent snowfall. The user will spend long hours outdoors. Please generate a comprehensive packing list optimized for cold and snowy conditions, including categories such as outerwear, base layers, footwear, accessories, electronic devices, documents, and health items. For each item, include a brief explanation. Tailor the recommendations for prolonged outdoor walking in cold weather.”

The server may also construct a family-oriented prompt sentence:
“A family of four (two adults and two children aged 4 and 7) is traveling to a sunny beach location for 6 days in August. The forecast is clear and hot with strong sunlight. Please provide a packing list including categories such as clothing, beach items, sun protection, children's items, health and safety items, and electronic devices. For each item, explain in one sentence why it is recommended, taking into account the strong sunlight and the presence of young children.”

The server constructs these prompt sentences using a defined template engine. The server maps internal codes for travel purpose, climate category, and emotional state into descriptive phrases. The server applies non-linear logic when assembling the prompt, for example, by including extra categories such as comfort items when the emotion analysis engine indicates a stressed user. This behavior is not a simple automation of human thought; rather, it is a structured computing process that uses emotion analysis as a technical control signal to adjust prompt content and structure in a deterministic way.

The server receives the generative AI model's output for the second prompt sentence and parses it into structured packing list data. Because the prompt sentence directs the model to group items into categories and to provide explanations, the server can implement a deterministic parser that expects category headings followed by bullet-point items. The server maps category headings to internal category codes and stores each item entry in the packing_list table with fields such as item_name, category_code, explanation_text, and confidence_score. The server may compute a confidence score by evaluating, for example, whether the AI-generated text matches predefined lexical patterns for each category.

By structuring the generative AI outputs in this way, the server reduces the complexity of text parsing and improves robustness. The server does not simply display free-form text; instead, the server converts the output into a machine-readable data structure that can be filtered, sorted, and synchronized with the terminal. This structured representation allows the server to avoid repeated AI calls when the user modifies minor details; the server can locally re-rank or selectively hide items using rule-based logic without regenerating the entire list.

The terminal receives the structured packing list data from the server and renders an interactive view. The terminal groups items by category and displays checkboxes or toggles next to each item. The user marks items as “packed” on the terminal, and the terminal transmits these state changes back to the server in an efficient format (for example, an array of item identifiers and boolean flags). The server updates the packing_list table accordingly. By storing the packing state centrally, the server allows the user to access the same checklist from multiple terminals.

The server achieves a technical improvement over conventional systems by tightly coupling data representation and prompt generation. The server's use of feature vectors, contextual encoding, and deterministic prompt templates enables more stable interactions with the generative AI model. The server uses pre-processed, normalized data structures instead of raw free-text input, which reduces the dimensionality of the problem and minimizes noise. This approach decreases the number of required model invocations and reduces processing load on the computation hardware, leading to faster response times and lower communication overhead.

The server further improves accuracy and personalization by incorporating emotion analysis results into computational steps. Whereas a human operator might intuitively adjust suggestions when a user appears stressed, the server systematically modifies its algorithms: for example, the server adjusts weights in the recommendation module or modifies template selection for the prompt sentences based on emotion labels. Because these modifications are processed through well-defined data structures and algorithms, the effect on destination ranking and packing list content can be tuned, evaluated, and optimized. This integration of emotional signals with contextual data processing constitutes an improvement in computer-based user modeling.

The server also improves data management. By unifying travel-related data, weather information, generative AI prompts, model outputs, and emotion analysis in a coherent schema, the server avoids redundant data retrieval and reduces inconsistency. The server can reuse stored weather_info and prompt_log entries when the user revisits a destination or slightly modifies travel dates, instead of recomputing all steps. This reuse reduces the number of external application programming interface calls and thereby reduces communication load and latency.

In another embodiment, the server hosts the generative AI model locally. The server stores model parameters in the storage device and loads them into a memory region associated with a hardware accelerator. The server executes a training pipeline in which it fine-tunes the generative AI model using domain-specific prompt-output pairs derived from historical correct packing lists and user feedback. During training, the server defines a loss function such as cross-entropy between model-generated tokens and reference tokens, and the server updates model weights using gradient-based optimization with a learning rate schedule and regularization terms. The server may perform data augmentation by paraphrasing prompt sentences and synthesizing alternative item descriptions to improve robustness. These training operations further constitute technical processing that enhances model performance and reduces error rates in packing list generation.

In yet another embodiment, the server employs alternative neural architectures, such as a hybrid model combining a transformer backbone with task-specific heads for classification of item categories. The server uses such heads to detect, in the AI output, whether each item belongs to a known category or requires new category creation. This hybrid modeling yields more reliable structured outputs and reduces the need for manual category assignment.

The server can also vary the configuration of the emotion analysis engine. In some embodiments, the server uses a convolutional neural network classifier applied to embedded sequences of user input tokens. In other embodiments, the server uses a transformer encoder with self-attention layers to derive emotion scores. The server may train this engine using supervised learning on labeled datasets, with a loss function such as categorical cross-entropy. The server optimizes hyperparameters such as embedding dimension, number of layers, and attention heads to achieve a desired tradeoff between accuracy and computational cost.

The terminal may be configured in various forms. In one variant, the terminal operates as a web browser executing scripts received from the server. In another variant, the terminal is a native mobile application. In both cases, the terminal uses local storage to cache user interface state and to reduce repeated data requests to the server. The terminal may perform limited local validation and formatting but does not execute the core recommendation or generative AI processing, which remains on the server.

The user may interact with the system in multiple ways. The user may accept or override recommendations, provide explicit ratings of destinations and packing list items, or update preferences over time. The server processes this feedback to update stored preference information and, when appropriate, to retrain or fine-tune the recommendation module and the generative AI model. This closed-loop learning process enables progressive improvement in output relevance and stability.

Through these embodiments and variations, the server, terminal, and user cooperate to implement the claimed system. The server performs concrete data processing and model interaction operations that go beyond simple automation of human reasoning, including feature extraction, neural inference, structured prompt generation, and structured output parsing. These operations improve the technical functioning of the computer system by increasing processing speed, improving accuracy of destination and packing list generation, reducing network traffic, and enabling robust and repeatable interactions with a generative AI model based on carefully designed prompt sentences and data structures.

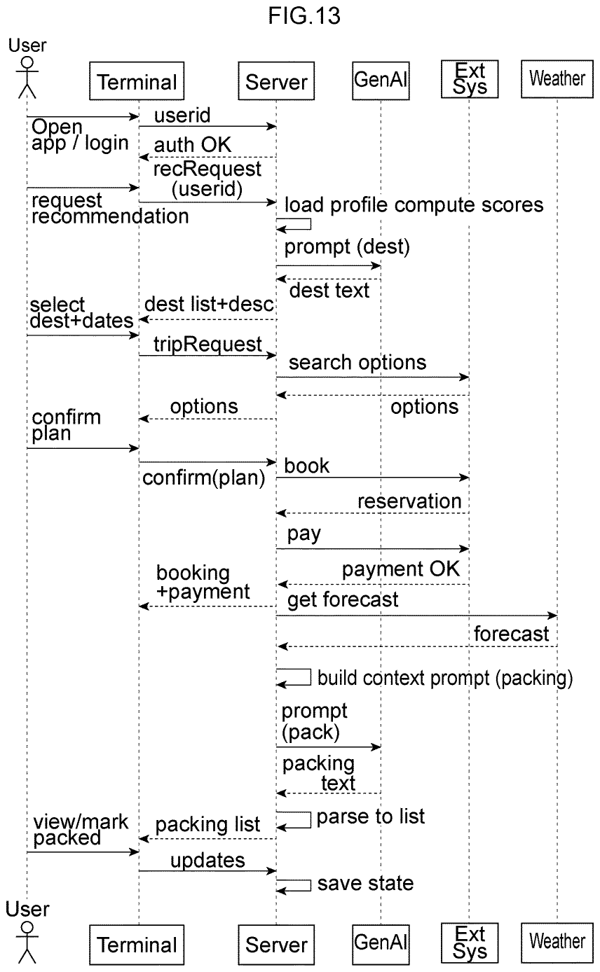

The following describes the processing flow using FIG. 13.

### Step 1

The user operates the terminal to start a travel support application and authenticate.
The terminal acquires, as input, user credentials or a stored user identifier from local secure storage, and transmits the user identifier to the server via a network request.
The server receives the user identifier as input, verifies the identifier against records in a user data table, and outputs an authentication result indicating whether the user is valid.
The terminal receives the authentication result and, when the result is positive, displays a home screen interface for travel recommendation and planning.

### Step 2

The user operates the terminal to request destination recommendations.
The terminal acquires, as input, the authenticated user identifier and optional filter parameters (for example, desired travel period or budget range) and transmits these as structured data to the server.
The server receives the user identifier and filter parameters as input, and outputs a destination recommendation request event that triggers retrieval of user-related information from storage.

### Step 3

The server acquires user-related information to prepare features for destination scoring.
The server uses the user identifier as input to query a storage device that maintains at least travel_history and preference records.
The server executes database read operations (for example, indexed lookups and joins) to obtain past trip records, explicit preference settings, and derived statistics, and the server outputs a user profile dataset containing normalized fields such as typical trip length, preferred climates, and spending level.

### Step 4

The server computes numerical destination scores using a recommendation module.
The server supplies the user profile dataset and a candidate destination catalog as input to a machine learning model (for example, a neural network or matrix factorization model) stored in memory.
The server performs data preprocessing operations, including categorical encoding, numerical normalization, and feature vector assembly, and then executes matrix multiplications and non-linear activation functions to obtain a score for each candidate destination.
The server outputs a ranked list of destination candidates with associated numerical scores.

### Step 5

The server generates a first prompt sentence for a generative AI model to enrich destination proposals.
The server receives the ranked list of destination candidates and the user profile dataset as input.
The server maps structured fields such as preferred climate, budget, and travel length into textual phrases using a template, concatenates those phrases with the names and brief descriptions of the top-ranked destinations, and forms a coherent prompt sentence for the generative AI model.
The server outputs the constructed prompt sentence as a string suitable for input to the generative AI model.
Example of a first prompt sentence:
“The user has previously enjoyed several warm coastal trips and prefers mid-range accommodation and moderate budgets. Based on this profile, the system has identified the following candidate destinations: Destination A (subtropical beach), Destination B (island resort), Destination C (coastal city). Please describe the advantages of each candidate for a 4-day leisure trip next month, and recommend which one is most suitable. Explain the reasoning in concise bullet points.”

### Step 6

The server invokes the generative AI model to obtain a natural-language destination explanation.
The server uses the prompt sentence from Step 5 as input and sends it via a model interface to a generative AI model running on dedicated computation hardware.
The generative AI model performs tokenization, embedding, multi-head self-attention computations, and feed-forward transformations to predict sequences of output tokens.
The server decodes the output tokens into a text response, and outputs a structured representation of destination descriptions and a recommended destination identifier.

### Step 7

The terminal presents enriched destination proposals and the user selects a destination.
The server transmits, as input to the terminal, the structured destination descriptions and recommendation ranking.
The terminal renders destination cards with descriptive text and highlights the recommended destination, and the terminal outputs the user's selection when the user taps on a preferred destination.
The terminal sends the selected destination identifier and user identifier back to the server as structured data.

### Step 8

The user specifies travel dates and trip details via the terminal.
The terminal receives as input the user's interactions with a date selector and other controls such as number of travelers and trip purpose.
The terminal assembles this information into a trip request object and outputs this object to the server via a network request.
The server receives the trip request as input and records the selected destination, dates, traveler count, and purpose in a temporary planning record.

### Step 9

The server communicates with an external reservation system to search for available services.
The server uses the destination identifier, schedule information, and traveler count from the planning record as input to construct an application programming interface request to an external reservation system.
The server formats this input into a standardized data structure, transmits it via the communication interface, and receives as output a list of available accommodation and transportation options expressed in a vendor-specific format.
The server normalizes these responses into internal reservation option records with fields such as price, availability, and quality score.

### Step 10

The terminal displays reservation options and the user confirms a plan.
The server transmits the normalized reservation option records as input to the terminal.
The terminal renders each option with summarized details, and the user inspects these and taps a confirm control for a chosen combination of accommodation and transportation.
The terminal outputs the identifiers of the chosen services and sends them back to the server for final reservation.

### Step 11

The server completes reservations and processes payment via an external payment apparatus.
The server uses the chosen service identifiers and user identifier as input to call the external reservation system again to finalize bookings, and the server outputs reservation information including reservation identifiers and price totals.
The server then uses the reservation information and a payment token received from the terminal as input to construct a payment request to the external payment processing apparatus.
The external payment processing apparatus processes authorization and capture, and the server receives payment completion information, which the server outputs as updated reservation records with confirmed payment status.

### Step 12

The server acquires weather information for the confirmed trip.
The server uses location information and schedule information from the reservation records as input to construct a request to an external weather information providing apparatus.
The server transmits geographic coordinates and date ranges via the communication interface and receives, as output, structured weather forecast data including temperature ranges, precipitation probabilities, and descriptive weather codes.
The server parses this data, transforms it into normalized weather_info records, and outputs a summary that includes, for each travel day, expected weather conditions.

### Step 13

The server analyzes user emotional state using an emotion analysis engine.
The server acquires user input information from the terminal, such as free-text comments or responses to short survey questions, as input to an emotion analysis engine.
The emotion analysis engine tokenizes the text, maps tokens to embeddings, processes the sequence through a neural classifier (for example, a transformer encoder), and computes probabilities over predefined emotion labels.
The server interprets these probabilities, selects dominant labels such as “anxious” or “relaxed,” and outputs an emotional state record associated with the user and the trip.

### Step 14

The server constructs context information for packing list generation.
The server uses as input the reservation records, weather_info summary, travel purpose information, and the emotional state record.
The server aggregates these inputs into a context object, performing computations such as determining trip length, computing temperature ranges, detecting severe weather conditions, and mapping emotion labels to adjustment flags (for example, “add comfort items” when anxious).
The server outputs a structured context representation that encodes all relevant numeric and categorical features for the packing list.

### Step 15

The server generates a second prompt sentence for the generative AI model based on the context.
The server takes the context representation as input and selects a template corresponding to the travel purpose and climate type.
The server fills template placeholders with actual values for destination description, dates, weather summary, and travel style, and conditionally inserts text corresponding to the emotional state adjustments.
The server outputs a prompt sentence for packing list generation, for example: “The user is going on a 4-day leisure trip to a subtropical island next week. The forecast is heavy rain with temperatures between 23 and 26 degrees Celsius and strong wind. The user will spend many hours walking outdoors for sightseeing and currently feels somewhat anxious about forgetting important items. Please generate a detailed packing list optimized for this context. Group items into categories (clothing, footwear, rain gear, accessories, electronic devices, documents, health items, and comfort items), and for each item provide a short explanation of why it is needed.”

### Step 16

The server invokes the generative AI model with the second prompt sentence to obtain a candidate packing list.
The server supplies the prompt sentence from Step 15 as input to the generative AI model.
The generative AI model processes the tokenized input through embedding layers and stacked attention layers to compute contextual representations and then generates output tokens representing item names, categories, and explanations.
The server decodes the tokens into plain text and outputs a raw packing list text that follows the requested category structure.

### Step 17

The server parses and structures the generated packing list.
The server takes the raw packing list text as input and applies deterministic parsing rules to identify category headings and associated item lines.
The server splits lines, removes formatting markers, and extracts item names and explanation segments using pattern matching and lexical cues (for example, colon-separated fields).
The server outputs structured packing list records, each record including at least an item name, a category code mapped from the category heading, and an explanation string.

### Step 18

The server stores and optimizes the packing list data.
The server uses the structured packing list records as input and writes them into a packing_list table associated with the user identifier and reservation identifier.
The server may perform additional computations, such as detecting duplicate or near-duplicate items by string similarity metrics, merging them, and marking some items as optional based on rules that consider weather severity and trip duration.
The server outputs a finalized packing list dataset ready for delivery to the terminal.

### Step 19

The server transmits the packing list to the terminal and notifies the user.
The server uses the finalized packing list dataset as input to construct a compact response message for the terminal and, optionally, a separate notification payload for a push notification service.
The server sends a notification message indicating that a weather-based packing list is ready and transmits the full dataset when the terminal requests detailed content.
The terminal receives the dataset as output from the server, renders the items grouped by category with checkboxes, and stores locally the initial “unpacked” state for each item.

### Step 20

The user uses the packing list on the terminal to prepare for travel.
The user views the list on the terminal, and the terminal receives user interactions (taps on checkboxes, additions of custom items, or deletions of unneeded items) as input.
The terminal updates local representations of the packing list and transmits change events (for example, item identifier and packed/unpacked status) to the server.
The server records these changes in the packing_list table, outputs an updated synchronized list, and thereby maintains a consistent, machine-readable representation of the user's preparation state across devices.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented travel assistance systems are typically configured as a collection of independent modules such as a destination search engine, a reservation interface, a payment interface, and a static packing checklist service. In such systems, user inputs are processed in a linear and siloed manner, and there is little or no coordinated control over how user context, emotion state, weather conditions, and historical behavior are combined. As a result, these systems often exhibit several technical problems from the standpoint of computer technology.

First, conventional systems generally rely on static rules or fixed templates to generate recommendations. Because these rules are not dynamically adapted based on feedback, each component (for example, recommendation, packing suggestion, notification) requires manual tuning. This leads to duplicated logic, increased memory consumption, and inefficient use of processing resources across multiple services. The systems are not configured to leverage a unified generative model interface with structured prompt control, and thus cannot flexibly adapt to complex contextual inputs without adding more hard-coded branches and data flow paths.

Second, conventional systems treat a generative AI model, when used, as a black-box text generator and do not systematically manage prompt sentences and generated outputs as machine-usable data. The systems do not record associations between prompts, generated results, and user interactions in a structured manner, and therefore cannot automatically refine prompt generation rules or control parameters. This limits the ability of the computing system to improve recommendation accuracy over time and forces developers to manually adjust prompts or model configuration, resulting in higher maintenance cost and reduced scalability.

Third, emotion analysis, where present, is usually implemented as an independent feature that merely adds a tag to user data. Such emotion information is not tightly integrated into the computational pipeline that controls destination selection, packing list generation, and notification logic. Consequently, emotion analysis imposes additional processing overhead but does not significantly contribute to the optimization of downstream computations. The lack of an integrated pipeline leads to redundant queries, unnecessary data transfers between services, and suboptimal use of computing resources.

Fourth, weather information and travel-purpose information are frequently used only as display data, rather than as primary inputs to a unified decision engine. Many systems separately query weather services and then merge the results with pre-defined packing templates on the application side. This scattered architecture leads to repeated weather queries, increased network traffic, and inconsistent handling of similar conditions, which in turn degrades the overall computational efficiency and responsiveness of the system.

Accordingly, there is a need for a computer-implemented system that integrates user behavior information, history information, attribute information, emotion analysis results, and external context information such as weather and travel purpose into a unified generative AI pipeline. Such a system should manage prompt sentences and generated outputs as structured data, use these records to refine prompt generation rules in a learning manner, and thereby improve both the quality and efficiency of travel destination proposals and packing list proposals. The technical problem to be solved is to provide an improved computer system and processing architecture that reduces duplicated logic, optimizes the use of a generative AI model and an emotion analysis engine, and enables adaptive, context-aware generation of travel-related information with reduced development and maintenance overhead.

The specific processing by the specific processing unit 290 of the data processing device 12 in Application Example 2 is realized by the following means.

The present invention provides a server comprising a processor configured to receive user information including behavior information, history information, and attribute information from a user terminal; to generate a prompt sentence for a generative AI model by using the user information as input, to input the prompt sentence to the generative AI model, and to cause the generative AI model to generate travel destination candidate information reflecting user preferences and user emotional states; to execute reservation processing for an accommodation means and a transportation means via an application programming interface of an external reservation service on the basis of the travel destination candidate information, and to acquire reservation result information; to execute settlement processing using an external electronic payment service on the basis of the reservation result information, and to acquire settlement result information; to acquire weather data from an external weather information service by using location information and date information corresponding to a planned travel location or a current location; to generate a prompt sentence for the generative AI model by using the weather data, the user information, and travel purpose information as input, to input the prompt sentence to the generative AI model, and to cause the generative AI model to generate packing list information corresponding to weather conditions and a travel purpose; to notify the packing list information to the user terminal and to cause display or management of the packing list information on the user terminal; to estimate an emotional state of the user by inputting text information or voice information of the user to an emotion analysis engine, and to include the emotional state in a prompt sentence to be input to the generative AI model so as to change the travel destination candidate information and the packing list information in accordance with the emotional state; and to store the prompt sentence input to the generative AI model, an output result generated by the generative AI model, and selection information or operation information by the user in association with each other, and to update a generation rule or a control parameter for the prompt sentence on the basis of the stored information so as to improve, in a learning manner, a proposal accuracy of the travel destination candidate information and the packing list information. This enables the computer system to implement an integrated, feedback-driven generative processing pipeline that uses structured prompt control and emotion-aware context fusion to dynamically optimize destination proposals and packing list generation, thereby improving computational efficiency, reducing redundant rule-based logic, and enhancing the technical performance of the travel assistance platform.

The term “processor” refers to a hardware or virtual computing element, such as a central processing unit or a processing core executed on a computing device, that executes instructions to perform data reception, analysis, generation, communication, and control operations described in the present specification.

The term “user information” refers to information related to an individual user, including at least behavior information, history information, and attribute information, which is used as input to analysis and generation processes.

The term “behavior information” refers to information indicating actions or operations performed by the user, including but not limited to application operations, selections, inputs, confirmations, and navigation behaviors within a service.

The term “history information” refers to information indicating past activities or records associated with the user, including but not limited to past travel records, previously selected destinations, past reservations, and prior interactions with a system.

The term “attribute information” refers to static or slowly changing user properties, including but not limited to demographic data, preference categories, budget ranges, and travel style classifications.

The term “user terminal” refers to an electronic device operated by the user, such as a portable information device, a personal computer, or a wearable device, which transmits user information to the server and presents information received from the server.

The term “generative AI model” refers to a software-implemented machine learning model configured to generate text or other content based on an input sequence, including but not limited to a neural network model trained to produce natural language responses from prompt sentences.

The term “prompt sentence” refers to a natural language or structured instruction string provided as input to the generative AI model, the content of which causes the generative AI model to execute a specific generation task such as proposing travel destinations or generating a packing list.

The term “travel destination candidate information” refers to information indicating one or more proposed travel destinations for a user, including identification data of the destinations and explanatory data describing reasons for the proposals.

The term “user preference” refers to a tendency or liking of the user for particular conditions, such as types of locations, activities, climates, price ranges, or travel styles, derived from user information and used in generation processes.

The term “user emotional state” refers to a psychological condition or affective state of the user, such as stress, excitement, relaxation, or fatigue, estimated on the basis of user inputs and used as a parameter in generation processes.

The term “application programming interface of an external reservation service” refers to a set of callable functions or communication endpoints provided by a reservation service operated on an external system, which the processor uses to request search, booking, or confirmation of accommodation means and transportation means.

The term “accommodation means” refers to facilities or services that provide lodging to a traveler, such as hotels, guesthouses, or similar lodging services.

The term “transportation means” refers to facilities or services that transport travelers between locations, such as aircraft, rail services, road vehicles, or other travel conveyances.

The term “reservation result information” refers to information returned from the external reservation service in response to a reservation request, including data such as reservation identifiers, dates, locations, conditions, and prices.

The term “external electronic payment service” refers to a payment processing system operated on an external computing environment, which performs transaction authorization and settlement based on payment-related data received from the processor.

The term “settlement result information” refers to information generated by the external electronic payment service in response to a payment request, including transaction identifiers, success or failure statuses, and error codes.

The term “external weather information service” refers to a network-accessible service that provides weather-related data for specified locations and times, which the processor queries using location information and date information.

The term “weather data” refers to data indicating meteorological conditions for a specified location and period, including but not limited to temperature, precipitation, weather conditions, and forecasts.

The term “location information” refers to data indicating a geographical position of a place, including identifiers such as coordinates, region codes, or place names used to query external services.

The term “travel purpose information” refers to information indicating a goal or intent of a particular travel, such as leisure, business, adventure, or relaxation, used as context in generation processes.

The term “packing list information” refers to information indicating items to be brought by the user for a travel, including item names, categories, and optionally quantities or notes.

The term “notification” refers to a transmission of data from the server to the user terminal to inform the user of generated information such as packing list information, travel destination candidate information, or updates related thereto.

The term “display or management of the packing list information” refers to operations performed by the user terminal to present packing list information on a user interface and optionally allow user interactions such as selection, confirmation, or editing.

The term “emotion analysis engine” refers to a software module or service configured to estimate an emotional state of the user on the basis of input data such as text information or voice-derived text.

The term “text information” refers to character-string data representing user input, including but not limited to messages, queries, or responses entered by the user through the user terminal.

The term “voice information” refers to audio data representing spoken input by the user, or text data obtained by converting such audio data by speech recognition processing.

The term “selection information” refers to data indicating choices made by the user among presented options, such as selected destinations, selected items, or confirmed proposals.

The term “operation information” refers to data indicating user interactions with the system or interface, including but not limited to button presses, menu selections, scrolling actions, or other input events.

The term “generation rule for the prompt sentence” refers to a set of conditions, templates, or algorithms that determine how a prompt sentence is constructed from one or more types of context information.

The term “control parameter for the prompt sentence” refers to a value used to adjust generation behavior of the generative AI model, including but not limited to parameters indicating temperature, length constraints, or weights for context elements embedded in the prompt sentence.

The term “learning manner” refers to a process in which the processor modifies at least one generation rule or control parameter for the prompt sentence on the basis of accumulated records of prompts, generated outputs, and user interactions, so that subsequent generation results are adjusted over time.

The term “storage means” refers to a memory device or data storage system, such as a local memory, a database, or a remote storage service, used to store user information, history information, generation logs, and related data.

The term “context information” refers to a combined set of data elements including at least one of user history information, user preference information, current emotional state information, current input conditions, weather data, period information, and activity type information, used to construct a prompt sentence.

The term “current input conditions” refers to information entered or specified in the course of an ongoing interaction, such as current travel dates, desired region, budget, companion information, or other real-time constraints.

The term “period information” refers to data indicating a temporal range related to a travel or activity, such as start dates, end dates, or durations.

The term “activity type information” refers to data classifying an intended activity or experience during travel, such as sightseeing, outdoor sports, cultural activities, or rest.

The term “notification information” refers to data generated by the processor and transmitted to the user terminal for presentation to the user, including but not limited to packing list information, travel destination candidate information, or status messages.

In one embodiment, a server executes a travel assistance system configured in accordance with the above-described claims. The server includes at least one processor, a main memory, a nonvolatile storage device, and a network interface, and operates on general-purpose computing hardware such as a rack-mounted computer system in a data center or a virtual machine in a cloud environment. The server executes an operating system such as a general-purpose server operating system and runs multiple software modules including a web service module, an application logic module, a generative AI module interface, an emotion analysis module interface, and a data storage interface.

The server communicates with a terminal operated by a user via a communication network. The terminal is, for example, a portable information device such as a smartphone, a personal computer, or a wearable device such as smart glasses. The terminal executes a client application implemented as a native mobile application or a web application, and provides a user interface including a chat display area, a list display area for travel destination candidates and packing lists, and input components for text, voice, and selection operations.

The server stores user information, logs, and model interaction data in a data storage subsystem. The data storage subsystem includes a relational database management system such as a structured query language-based database, and may further include a key-value store such as an in-memory cache system for frequently accessed items. The server defines data structures, for example, a user_profile table, a travel_history table, a prompt_log table, a generation_result table, a payment_record table, and a weather_cache table. Each table has fields such as a primary key, a user identifier, timestamps, context fields, and serialized representations of prompt sentences and model outputs.

The server uses a generative AI model implemented as a transformer-based neural network. In one embodiment, the generative AI model is a decoder-only transformer neural network with multiple self-attention layers, feed-forward layers, layer normalization, and positional encoding. The model processes input tokens representing prompt sentences and outputs tokens representing generated text such as destination proposals and packing lists. The server may deploy the generative AI model as an external model service accessed via an application programming interface, or as an internally hosted model executing on hardware accelerators such as graphics processing units.

The server configures the generative AI model by setting parameters such as model size (for example, number of layers, number of attention heads, hidden dimension size), generation parameters (for example, temperature, top-k or top-p sampling thresholds, maximum output length), and tokenization rules. The server defines a prompt construction algorithm that converts structured context information into a prompt sentence. The context information includes user behavior information, history information, attribute information, emotion state information, weather data, travel purpose, period information, and activity type information. The server uses template-based and rule-based logic to arrange these elements in a defined textual structure, thereby generating a prompt sentence that directs the generative AI model to perform a specific generation task.

The server trains or fine-tunes the generative AI model using supervised learning or reinforcement learning from human feedback. The server collects training examples consisting of input prompt sentences and desired output texts for travel destination proposals and packing lists. The server defines a loss function such as a cross-entropy loss between the model output probabilities and target tokens. The server updates model weights using an optimization algorithm such as stochastic gradient descent or an adaptive method. The server may apply data augmentation techniques including paraphrasing of prompts, introduction of noise into context fields, and sampling of different weather and emotion combinations, so that the model learns robust mappings from context to proposals. By explicitly modeling these combinations, the system improves the accuracy and diversity of generated results compared to static templates.

The server uses an emotion analysis engine implemented as a neural network classifier or a sequence model. In one embodiment, the emotion analysis engine is based on a bidirectional transformer encoder trained on labeled emotion data. The server inputs tokenized user text or speech recognition output into the emotion analysis engine and receives probability scores for emotion categories such as stress, excitement, relaxation, and fatigue. The server may apply a decision rule such as argmax over emotion probabilities or threshold-based selection for multi-label cases. The server stores the resulting emotion state in the user_profile table with a timestamp, and also associates the emotion state with the corresponding prompt_log entry.

The server configures an algorithm that explicitly uses the emotion state as a feature in prompt construction. For example, the server injects phrases or constraints into the prompt sentence indicating that the user “currently feels stressed and desires relaxation” or “currently feels excited and prefers adventure.” This approach differs from human operators or conventional rule-based systems, which would manually interpret emotion and compose separate queries. In the present system, the server uses a unified machine-readable representation of emotion, preference, and context, and composes prompt sentences according to predefined templates. This structured prompt generation reduces ambiguity and leads to more predictable model behavior, thereby improving computational efficiency and reducing the need for repeated manual tuning.

The server accesses external reservation services via application programming interfaces. The server sends structured requests consisting of location identifiers, travel dates, number of travelers, and budget constraints. When the external service returns a set of options in a structured format, the server parses the response and stores key fields in the database in a normalized form. The server may also call the generative AI model with a prompt sentence that includes a list of options and instructs the model to rank or filter these options according to user preferences and emotion state. This use of the generative AI model as a ranking and summarization engine allows the server to offload complex multi-criteria reasoning from deterministic application logic to a learned model. As a result, the server can reduce the amount of explicit rule code required, minimize maintenance overhead, and adjust behavior by modifying prompt templates rather than altering the entire code base.

The server interacts with an external electronic payment service. The server receives a payment token from the terminal, encapsulates it in a payment request including amount, currency, and booking identifiers, and transmits the request to the payment service. The payment service returns a transaction status and identifiers, which the server persists in the payment_record table. Because the server maintains a uniform data schema linking reservation records, payments, prompts, and generation results, the system can efficiently trace and analyze entire transaction flows. This structured linkage enables downstream analysis and contributes to improved fraud detection and anomaly detection, which can be implemented by additional models trained on these linked records.

The server retrieves weather data from an external weather information service by submitting requests specifying geographic location and time range. The server stores raw weather responses in the weather_cache table with a location key and a validity interval. When the server needs to construct a packing list, the server first checks the weather_cache to avoid redundant outbound requests. This cache-based mechanism reduces network load and improves response speed, thereby providing a technical effect beyond simple information relaying.

The server converts weather data, travel dates, and activity types into a compact representation. For example, the server maps numeric temperature and precipitation values to symbolic descriptors such as “cold,” “hot,” “rainy,” “snowy,” and “clear.” The server then uses these descriptors in prompt sentences. This mapping reduces input dimensionality and helps the generative AI model generalize across similar conditions. Because the server performs such preprocessing before invoking the generative AI model, the system reduces the volume and complexity of tokens fed into the model, which leads to faster inference time and lower computational resource consumption.

The server records each interaction with the generative AI model in the prompt_log and generation_result tables. Each record includes the prompt sentence, model configuration parameters, generated text, derived structured data, and user feedback such as selections and edits. The server defines an update algorithm that periodically analyzes these logs to refine prompt templates and model usage parameters. For example, the server can compute statistics on how often particular destination types are selected when recommended under certain emotion states and weather conditions. The server may adjust weights in the prompt templates, such as emphasizing “quiet” descriptors for stressed users or reducing suggestion of outdoor activities during heavy rain. By doing so, the server implements a learning-based feedback loop that modifies prompt construction rules rather than only retraining the model. This modification significantly reduces retraining cost and improves adaptability, representing an improvement in the way the computing system orchestrates model usage.

The terminal presents information to the user through graphical and conversational interfaces. The terminal receives structured JSON responses from the server and renders them as user-friendly elements such as cards for destinations, bullet lists for packing items, and timeline views for trips. The terminal may locally store a subset of packing list data for offline access, and may provide status tracking such as marking items as packed or completed. The terminal may also use device-specific features, such as location sensors and notification frameworks, to trigger reminders at appropriate times, such as when the user approaches the departure time or enters a store. By combining server-side intelligent generation with terminal-side context detection, the system achieves a tighter integration between computation and real-world conditions than simple human-driven procedures.

The user interacts with the system primarily through the terminal. The user enters text specifying travel intents, budget, dates, and subjective states (“I am tired and want to relax”) and may also speak queries that are transcribed by a speech recognition engine. The user reviews suggested destinations and packing lists, accepts or rejects proposals, and makes explicit selections for bookings. The user implicitly provides feedback when skipping certain items or modifying packing lists, and this behavior is captured as selection information and operation information for further analysis by the server.

The server uses specific example prompt sentences to drive the generative AI model in various contexts. Example prompt sentences include:
“The user prefers quiet beach destinations, has a history of trips to coastal regions, and currently feels stressed and wants to relax. The budget is 1,000 units of currency for 4 days in early April, departing from a major city. Propose three specific destinations with short explanations, focusing on calm, low-noise, relaxing experiences.”
“The user will travel to a metropolitan area from 2023-12-01 to 2023-12-03. The forecast is: Day 1: rain, 12 degrees; Day 2 cloudy, 15 degrees; Day 3 clear, 18 degrees. The user prefers casual clothing and light luggage. List a concise packing list including clothing and weather-related items. Output as bullet points.”
“Today's weather for a delivery worker is heavy rain, 8 degrees, in an urban region. List essential clothing and equipment for staying dry and safe during bicycle deliveries. Output as a short bullet list.”
“The user is preparing for a weekend trip to a quiet resort and currently feels stressed. Suggest 5 additional items that may help the user relax during the trip, such as relaxation tools or entertainment. Output only the item names.”
“A customer just entered a clothing and lifestyle store on a rainy day. The customer feels tired and stressed and forgot their umbrella. Suggest 3 concrete products that the store could recommend, including at least one rain-related item and at least one relaxation item. Output as: product name—short reason.”

By designing prompt templates and context injection rules in this way, the server converts heterogeneous data (history, weather, emotion, purpose) into a compact, model-friendly representation. This design yields technical advantages. The generative AI model processes token sequences more efficiently than if the raw data were naively concatenated, and the resulting outputs are structured for direct parsing into database fields. As a result, the system reduces both computational and post-processing overhead compared to prior approaches that require extensive rule-based parsing of unstructured text.

In another embodiment, the server may use multiple generative AI models specialized for different tasks, such as one model for destination generation and another for packing list generation. The server selects an appropriate model based on task type and context. For example, the server may choose a smaller, faster model for packing list generation to achieve lower latency, while using a larger model for complex destination reasoning. The server maintains separate prompt construction rules for each model and may share some context fields between them. This modular design allows the system to optimize resource usage while maintaining high-quality outputs.

In a further embodiment, the server may implement an attention-based fusion network that combines outputs of the emotion analysis engine and the generative AI model. For instance, the server can train an auxiliary neural network to re-rank destination candidates by taking as input embeddings of generated text and emotion vectors. The auxiliary network outputs adjusted scores used to refine the final list of destinations. This architecture further separates concerns: the generative AI model focuses on content generation, while the auxiliary network refines choices according to emotion and historical feedback. This separation improves interpretability and enables targeted improvements to specific components without disrupting the entire system.

The described system provides technical effects beyond mere automation of human planning. By storing and reusing structured prompt and response records, the server reduces repetitive requests to external services, minimizes token lengths and model calls for recurrent contexts, and achieves lower average latency. By integrating weather caching and emotion-aware context mapping, the system avoids unnecessary recomputation for similar travel scenarios. These optimizations result in reduced processor load and network traffic, which are concrete improvements in computer operation.

The server's architecture, which unifies generative AI processing, emotion analysis, external service integration, and learning-based prompt refinement within a coherent data model, enables superior management of large-scale, multi-source context information. This design allows the server to maintain consistent behaviors across updates, apply global changes via template modification, and systematically track the impact of such changes using logs. Consequently, the invention improves the reliability, maintainability, and scalability of the computing system itself, rather than merely improving a business procedure.

Various modifications and alternative configurations are possible. The server may be implemented as a distributed system with multiple processors, each responsible for a subset of tasks such as emotion analysis, weather handling, or booking orchestration. The terminal may perform partial pre-processing, such as local emotion estimation, and send only compact emotion labels to the server, thereby reducing uplink bandwidth requirements. The generative AI model may be replaced or supplemented by other sequence models as they become available, provided that the prompt sentence mechanism and feedback loop based on stored interaction data are preserved. In all such embodiments, the core concept that the server constructs and refines prompt sentences using integrated context, and uses a generative AI model to generate and adapt travel destination candidates and packing lists based on that context, remains consistent.

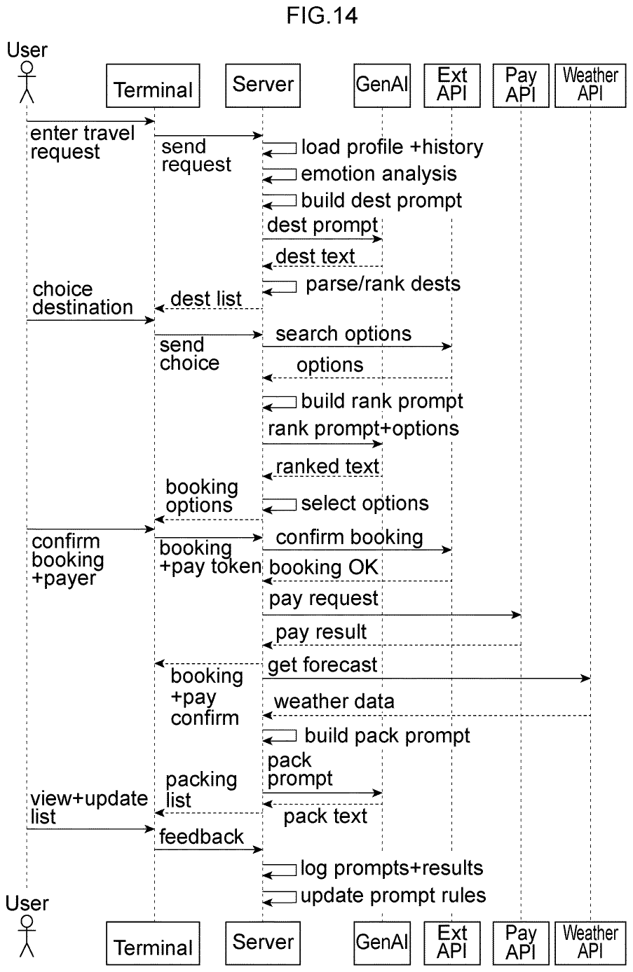

The following describes the processing flow using FIG. 14.

### Step 1:

User inputs travel-related information.
User enters travel intent, constraints, and optional emotion-related text on the terminal, for example, “I want a relaxing trip to a warm place in early April with a budget of 1,000 units of currency,” and optionally “I feel very stressed lately.”
Input: free-text message(s) and optional structured fields (dates, budget, number of travelers).
Output: a request payload composed of text fields and structured fields inside the terminal.

### Step 2

Terminal transmits user information to the server.
Terminal packages the user input into a structured message, for example, a JSON object containing user identifier, text message, optional speech transcript, and metadata such as timestamp and language code. Terminal sends this message to the server over a secure channel.
Input: internal request payload holding user text and structured parameters.
Output: network message delivered to the server containing user information and metadata.

### Step 3

Server stores raw user information and retrieves user profile data.
Server receives the network message, extracts the user identifier, and stores the raw text and parameters in a log table or storage record. Server queries a database using the user identifier to obtain behavior information, history information (past trips, accepted suggestions), and attribute information (preference categories, typical budget ranges).
Input: user information from the terminal and a user identifier.
Output: a combined context object containing raw current input and retrieved profile records.

### Step 4

Server performs emotion analysis.
Server sends the user text (and optionally recent texts or speech transcripts) to an emotion analysis engine. The emotion analysis engine returns scores for emotion classes such as “stressed,” “excited,” or “relaxed.” Server selects the dominant emotion and attaches it to the context object.
Input: user text or speech-derived text from the context object.
Output: an emotion label and associated probability scores stored as part of the context.

### Step 5

Server constructs a prompt sentence for destination generation.
Server converts the context object (history, preferences, current constraints, emotion) into a prompt sentence according to predefined templates. Server arranges textual fragments so that the generative AI model receives a clear instruction, for example:
“The user prefers quiet beach destinations, has a history of trips to coastal regions, and currently feels stressed and wants to relax. The budget is 1,000 units of currency for 4 days in early April, departing from a major city. Propose three specific destinations with short explanations, focusing on calm, low-noise, relaxing experiences.”
Input: context object containing profile data, current input, and emotion label.
Output: a destination-generation prompt sentence stored in a prompt log and passed to the model interface.

### Step 6

Server generates destination candidates using a generative AI model.
Server sends the prompt sentence and generation parameters (for example, temperature, max tokens) to the generative AI model via an API or local call. The generative AI model processes the tokenized prompt using transformer layers and outputs a text response listing destinations and reasons. Server receives the response and parses it into structured destination candidate records (destination name, region, description, rough cost).
Input: prompt sentence and generation parameters.
Output: structured travel destination candidate information derived from the model's text output.

### Step 7

Server refines and stores destination candidates.
Server filters and ranks the candidate destinations based on rules (for example, remove restricted regions, enforce budget limits). Server may adjust scores using the emotion label and preference weights. Server writes the resulting candidate list into a travel suggestion table linked to the current session.
Input: raw destination candidate information from the previous step and policy rules.
Output: a refined destination candidate list ready to be presented to the user.

### Step 8

Server transmits destination suggestions to the terminal.
Server formats the refined list into a response message including destination names, summaries, and short justifications. Server sends this message back to the terminal.
Input: refined destination candidate list.
Output: network response containing destination suggestions and explanatory text.

### Step 9

Terminal displays destination suggestions and collects user selection.
Terminal receives the suggestions, renders them as user interface elements (cards, list items), and displays explanations such as “Recommended because it has quiet beaches and spa facilities.” User selects one destination or requests alternative options by interacting with the interface.
Input: destination suggestion response from the server.
Output: user selection or additional query constructed as a new request payload.

### Step 10

Terminal sends the selected destination and travel constraints to the server.
Terminal encapsulates the chosen destination identifier, travel dates, number of travelers, and any modified constraints (for example, updated budget) and sends this information to the server.
Input: user selection and updated travel parameters.
Output: network message containing a specific destination choice and constraints.

### Step 11

Server searches for reservations via external reservation APIs.
Server receives the selected destination and constraints and composes a request to an external reservation service API. Server includes location codes, check-in and check-out dates, traveler counts, and budget filters. Server sends the request, receives a list of accommodation and transportation options, and parses the returned structured data.
Input: selected destination and travel parameters, plus external API configuration.
Output: structured reservation option data for accommodations and transportation.

### Step 12

Server optionally uses a generative AI model to rank reservation options.
Server prepares a prompt sentence embedding the reservation options as text and instructing the model to rank or summarize them, for example:
“From the following list of hotels and flights, select three options that best match the user's preference for quiet and relaxation and the given budget. Explain each choice briefly.”
Server sends the prompt sentence to the generative AI model, receives a ranked list or annotated text, and maps the model's descriptions back to the original options.
Input: reservation option data and a ranking prompt sentence.
Output: a ranked subset of reservation options with associated justification text.

### Step 13

Server returns ranked reservation options to the terminal.
Server formats the ranked options into a response containing prices, conditions, and short explanations. Server transmits this response to the terminal.
Input: ranked reservation option data.
Output: network message containing curated booking options.

### Step 14

Terminal displays ranked booking options and obtains booking confirmation.
Terminal renders the booking options, showing prices, dates, and brief reasons for recommendation. User reviews the options and confirms a chosen combination of accommodation and transportation.
Input: curated booking options from the server.
Output: user booking confirmation and associated traveler details to be sent to the server.

### Step 15

Terminal sends booking confirmation and traveler details to the server.
Terminal collects traveler names, contact information, and any special requests, then transmits these details along with selected option identifiers to the server.
Input: user-confirmed booking selection and traveler data.
Output: booking confirmation request delivered to the server.

### Step 16

Server completes reservation and acquires reservation result information.
Server calls the external reservation service API with the selected option identifiers and traveler details. The reservation service responds with reservation numbers, ticket identifiers, and status. Server validates the response, stores reservation result information in a reservation table, and links it to the user and session.
Input: booking confirmation request and external reservation API response.
Output: reservation result information stored in structured form.

### Step 17

Terminal acquires payment token and sends it to the server.
Terminal invokes a payment user interface (for example, a payment SDK) and obtains a payment token representing the user's payment method. Terminal sends the payment token, amount, and relevant booking identifiers to the server.
Input: user's payment confirmation and payment token.
Output: payment request message addressed to the server.

### Step 18

Server executes settlement processing using an external payment service.
Server builds a payment request containing the payment token, transaction amount, currency, and booking identifiers and sends it to an external electronic payment service. The payment service returns a status (success or failure) and transaction identifiers. Server stores settlement result information in a payment_record table and associates it with the reservation record.
Input: payment request data and external payment service response.
Output: settlement result information indicating payment success or failure.

### Step 19

Server notifies the terminal of booking and payment completion.
Server constructs a confirmation message summarizing booked items, dates, and a payment status. Server sends the message to the terminal.
Input: reservation result information and settlement result information.
Output: confirmation response transmitted to the terminal for user display.

### Step 20

Server retrieves or caches weather data for upcoming trips.
Server periodically scans upcoming reservations and, for each trip within a defined time window, obtains geographic coordinates or city identifiers. Server queries an external weather information service, receives forecast data, and stores it in a weather cache keyed by location and date.
Input: reservation data containing location and date information.
Output: weather cache entries containing weather data for planned trips.

### Step 21

Server constructs a prompt sentence for packing list generation.
Server retrieves weather data, travel dates, activity type, and user preferences and emotion state for a given trip. Server converts numeric weather values into symbolic categories and combines these with preferences into a prompt sentence, for example:
“The user will travel to a metropolitan area from 2023-12-01 to 2023-12-03. The forecast is: Day 1: rain, 12 degrees; Day 2 cloudy, 15 degrees; Day 3 clear, 18 degrees. The user prefers casual clothing and light luggage. List a concise packing list including clothing and weather-related items. Output as bullet points.”
Input: weather data, reservation details, user preferences, and emotion label.
Output: a packing-list-generation prompt sentence for input to the generative AI model.

### Step 22

Server generates a packing list using the generative AI model.
Server sends the packing prompt sentence to the generative AI model. The model returns a text list of items and possibly quantities. Server parses the text, segments items, and normalizes names into structured records (for example, category=“clothing,” item=“light jacket,” quantity=1).
Input: packing prompt sentence and model configuration.
Output: structured packing list information stored for the corresponding trip.

### Step 23

Server adjusts the packing list using emotion context.
Server examines the stored emotion state (for example, “stressed” or “excited”) and constructs an additional prompt sentence to augment the packing list, for example:
“The user is preparing for a weekend trip to a quiet resort and currently feels stressed. Suggest 5 additional items that may help the user relax during the trip, such as relaxation tools or entertainment. Output only the item names.”
Server sends this supplemental prompt to the generative AI model, receives additional items, and combines them with the main packing list, marking them as emotion-based suggestions.
Input: current packing list, emotion label, and supplemental prompt sentence.
Output: enhanced packing list including emotion-aware items.

### Step 24

Server sends packing list notifications to the terminal.
Server generates notification messages (for example, “Please bring a light jacket and an umbrella for your trip”) and pushes them to the terminal. The messages may be scheduled to appear a certain time before departure.
Input: final packing list data for a trip.
Output: notification messages delivered to the terminal.

### Step 25

Terminal displays and manages the packing list.
Terminal shows the packing items as a checklist, allowing the user to mark items as packed or edit the list. Terminal may update the server with the user's selections and modifications, so that selection information and operation information are recorded for learning.
Input: packing list notification from the server.
Output: updated user interaction data (packed flags, edits) returned to the server.

### Step 26

Server logs prompts, model outputs, and user feedback.
Server stores each prompt sentence, generative AI model output, and corresponding user interaction (for example, which destinations were chosen, which packing items were accepted or removed) in log tables. Server ensures that each record is linked by identifiers and timestamps.
Input: prompt sentences, model responses, and user interaction events.
Output: log records forming a history of model usage and user behavior.

### Step 27

Server analyzes logs and updates prompt generation rules.
Server periodically runs analysis routines over the log records. Server computes metrics such as selection rates of items or destinations under certain weather and emotion conditions. Based on these metrics, server adjusts prompt templates or control parameters (for example, increasing emphasis on “quiet” destinations when stress is detected, or reducing rain gear suggestions above certain temperatures). Server writes updated rules into configuration storage, so that future prompt sentences reflect learned preferences and produce more accurate outputs.
Input: accumulated log data including prompts, outputs, and user feedback.
Output: updated prompt generation rules and control parameters used in subsequent model invocations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

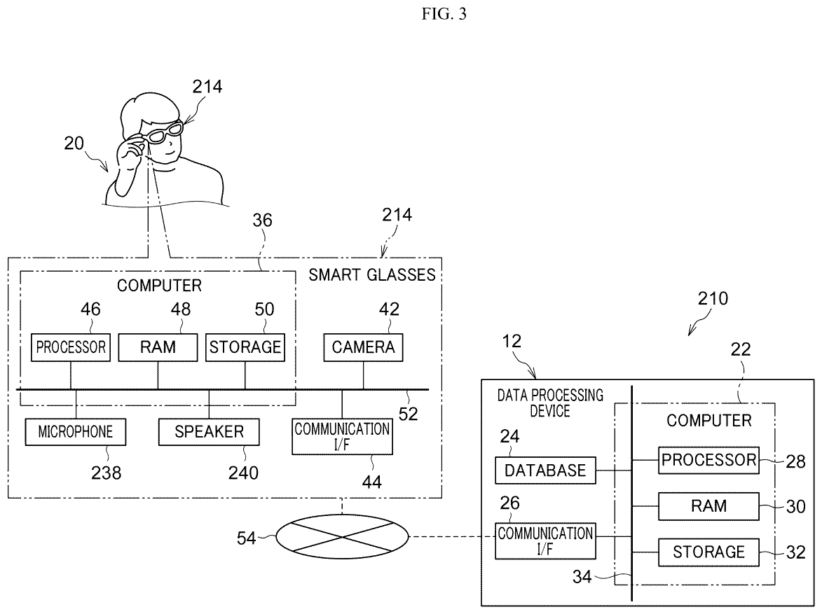

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

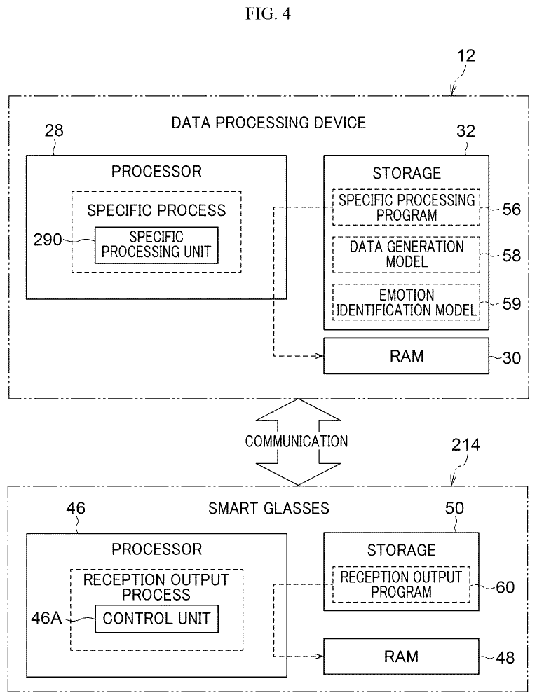

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

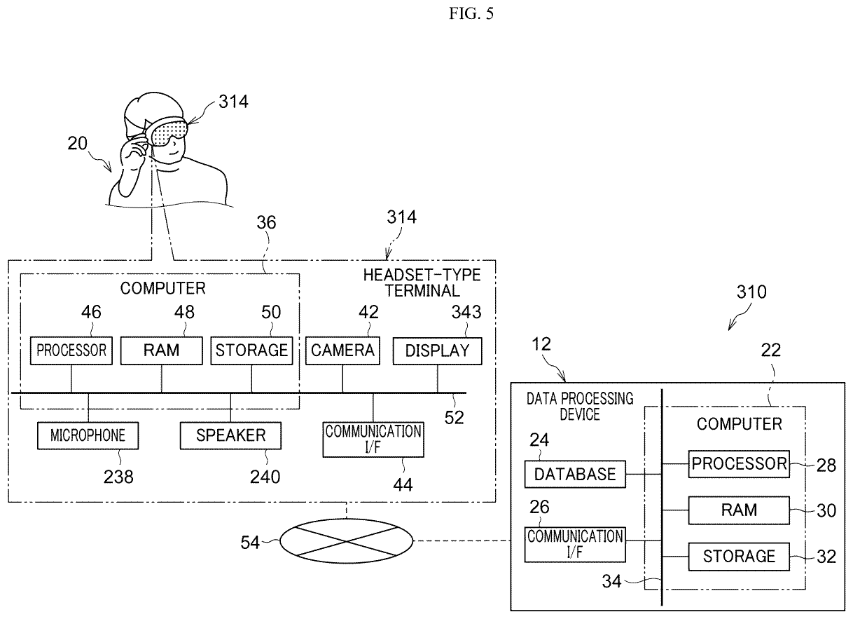

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

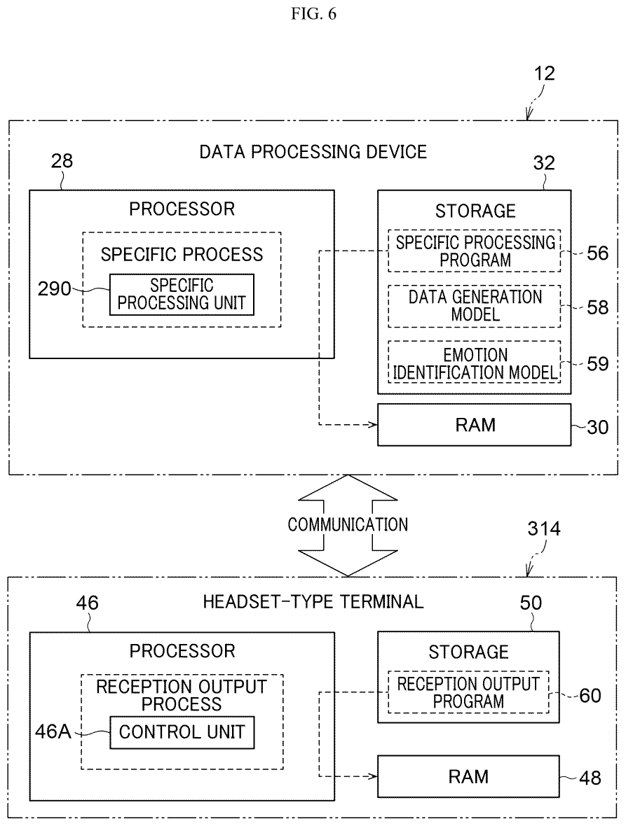

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

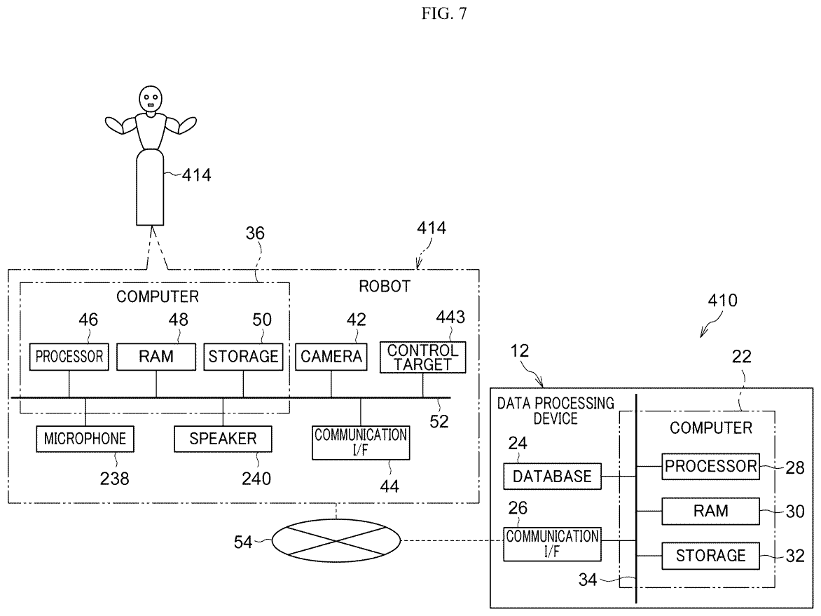

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

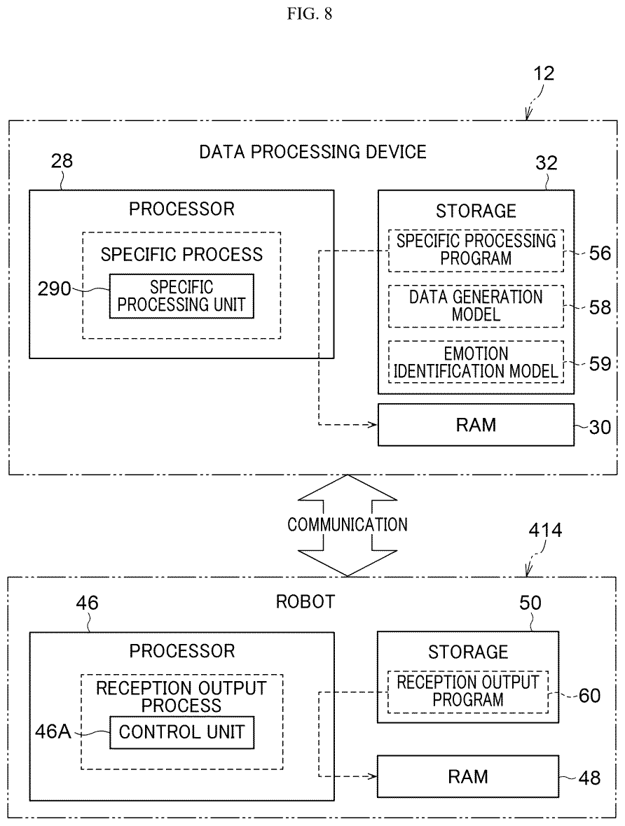

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

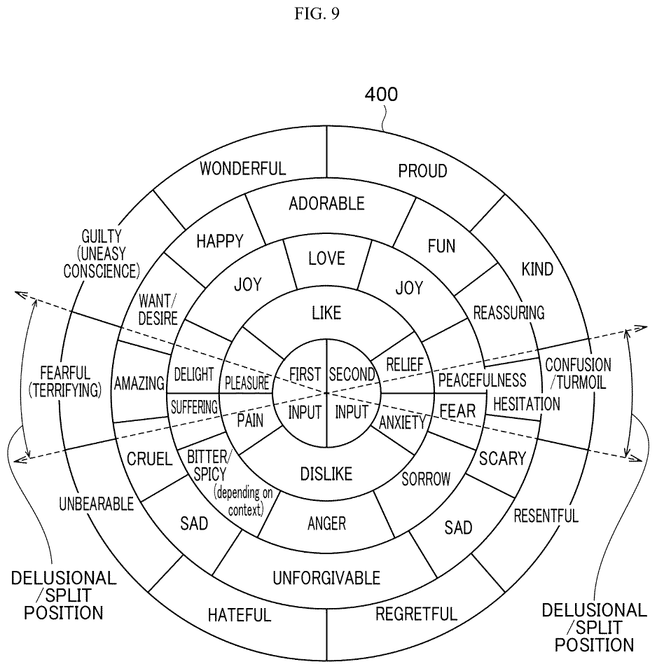

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

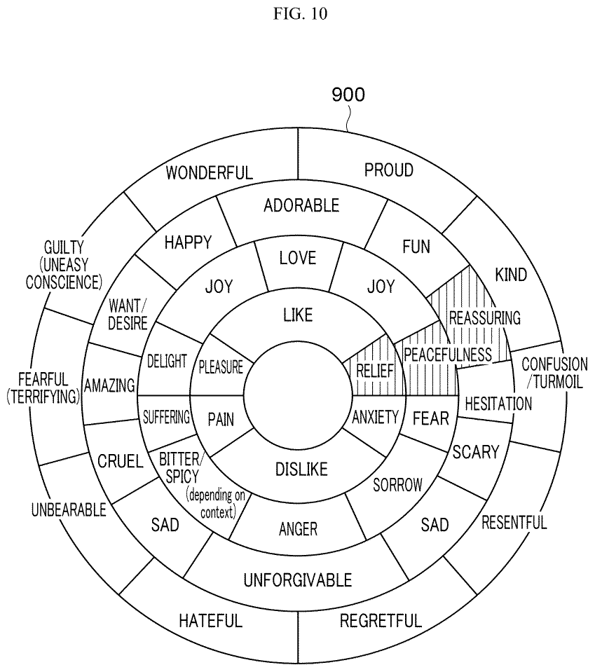

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive natural language information related to travel from a user terminal,
acquire, from an information storage device, past behavior history information and preference information of a user based on the received natural language information and user identification information,
generate, based on the acquired past behavior history information and preference information and the received natural language information, an analysis input text as a prompt sentence, input the analysis input text into a generative AI model, cause the generative AI model to generate a candidate set of travel destinations suitable for the user's preferences, and extract one or more travel destination candidates from the candidate set,
present the extracted travel destination candidates to the user terminal and acquire, from the user terminal, travel destination selection information and schedule information including date information, number-of-travelers information, and budget information,
generate, based on the travel destination selection information and the schedule information, reservation request data for calling a reservation application programming interface provided by an external travel reservation information processing device, execute reservation processing for accommodation services and transportation services via the reservation application programming interface, and acquire reservation result information,
generate, based on the reservation result information, payment request data for calling a payment processing service application programming interface, cause an electronic payment process to be completed via the payment processing service, and acquire payment result information,
acquire, based on travel destination information and date information included in the reservation result information, weather information for a travel period from a weather information providing device,
generate, based on the acquired weather information, travel destination type information, season information, and travel purpose information, a description input text as a prompt sentence,
input the description input text into the generative AI model and cause the generative AI model to generate a packing list including a list of items to be carried for the travel,
notify the user terminal of the generated packing list and the acquired weather information, analyze expressions included in natural language input from the user by using a sentiment analysis engine to extract an emotional state of the user,
add the extracted emotional state to at least one of the analysis input text and the description input text, input the emotional-state-added text into the generative AI model, and cause the generative AI model to adjust at least one of the travel destination candidates and the packing list according to the emotional state, and
in response to additional condition input from the user, generate a new prompt sentence, re-input the new prompt sentence into the generative AI model, and iteratively update at least one of a travel plan and the packing list.

### Supplementary 2

The system according to supplementary 1,
wherein the processor is configured to
acquire the past behavior history information and the preference information of the user from the information storage device, generate a travel destination generation instruction prompt sentence including the past behavior history information, the preference information, and current natural language input, and input the travel destination generation instruction prompt sentence into the generative AI model.

### Supplementary 3

The system according to supplementary 1,
wherein the processor is configured to
generate a packing generation instruction prompt sentence including travel destination information, travel period information, weather information, travel purpose information, and emotional state information of the user, input the packing generation instruction prompt sentence into the generative AI model, and notify the user terminal of a packing list generated by the generative AI model.

Application Example 1

### Supplementary 1

A system comprising a processor and a storage device,
wherein the processor is configured to
receive user input information obtained from a user information processing terminal,
acquire, from the storage device, history information and preference information relating to a user, based on the user input information and user identification information associated with the user input information,
generate, based on the user input information, the history information, and the preference information, a first prompt sentence to be input to a generative information processing model, and input the first prompt sentence to the generative information processing model to cause the generative information processing model to generate movement destination candidate information adapted to the user,
present, based on the movement destination candidate information, the movement destination candidate information to the user information processing terminal via a dialog response processing unit, and receive movement destination information selected by the user,
search, based on the selected movement destination information and reservation condition information including movement period information, cost information, and number-of-persons information, accommodation arrangement information and movement arrangement information via a communication interface of an external reservation service, and execute reservation processing for at least part of the accommodation arrangement information and the movement arrangement information to acquire reservation result information,
execute payment processing via a communication interface of an external payment service based on the reservation result information and user payment information, and acquire payment result information,
acquire weather prediction information from an external weather information service based on the selected movement destination information and the movement period information,
generate, based on the weather prediction information, the movement destination information, the movement period information, and attribute information of the user included in context information, a second prompt sentence to be input to the generative information processing model, and input the second prompt sentence to the generative information processing model to cause the generative information processing model to generate portable article candidate information,
post-process the portable article candidate information to generate portable article information by performing at least one of duplicate-item removal, classification assignment, and display-format conversion, and notify the portable article information to the user information processing terminal via the dialog response processing unit,
input at least one of text information and sound information included in the user input information to an emotion analysis engine, and acquire an emotion analysis result indicating an emotional state of the user,
adjust content of at least one of the first prompt sentence and the second prompt sentence based on the emotion analysis result, and change at least one of the movement destination candidate information and the portable article candidate information according to the emotional state, and
present, in an integrated manner, the reservation result information, the payment result information, the weather prediction information, and the portable article information to the user information processing terminal, and update the history information based on presented content and use the updated history information for subsequent input to the generative information processing model.

### Supplementary 2

The system according to supplementary 1,
wherein the processor is configured to
generate user feature information by numericalizing the history information and the preference information as feature quantities, and embed the user feature information into the first prompt sentence to be input to the generative information processing model, thereby causing the generative information processing model to generate structured data including a plurality of movement destination candidate pieces of information and respective reason information, and rank the movement destination candidate information for presentation based on the structured data.

### Supplementary 3

The system according to supplementary 1,
wherein the processor is configured to
generate the second prompt sentence by using as input the weather prediction information, the movement destination information, and the movement period information, and by including a travel-purpose type and the attribute information of the user as conditions, input the second prompt sentence to the generative information processing model to acquire the portable article candidate information, and convert the acquired portable article candidate information into presentation information in a checklist format for display on the user information processing terminal.

### Example 2

### Supplementary 1

A system comprising a processor, a storage device configured to store user-related information, and a communication interface configured to communicate with at least one external information processing apparatus, at least one external payment processing apparatus, at least one external weather information providing apparatus, at least one external generative AI model, and at least one user terminal,
wherein the processor is configured to
acquire, from the storage device, user-related information including travel history information and preference information of a user, and compute destination candidates based on the acquired user-related information, and perform a destination proposal process for the user based on the computed destination candidates,
generate a prompt sentence that instructs generation of destination candidates, the prompt sentence being based on the acquired user-related information, and input the prompt sentence into the generative AI model so that the generative AI model generates the destination candidates, and present a result of the generation as a destination proposal to the user via the user terminal,
execute, based on a destination and schedule information selected by the user from among the destination candidates, a reservation process for an accommodation facility and a transportation facility by using a reservation function of an external reservation system via the external information processing apparatus, and acquire reservation information as a result of the reservation process,
execute, based on the acquired reservation information, an electronic payment process by using a payment function of the external payment processing apparatus, and acquire payment completion information as a result of the electronic payment process, acquire, based on location information and schedule information included in the reservation information, weather information for a travel destination from the external weather information providing apparatus,
integrate the acquired weather information, the user-related information, and travel condition information, automatically generate a prompt sentence that instructs generation of a packing list corresponding to weather conditions, season, and travel purpose, and input the prompt sentence into the generative AI model so that the generative AI model generates the packing list,
generate the packing list as structured data including classification information indicating categories of items and explanation information indicating reasons for each item, and transmit the structured data to the user terminal so as to notify the packing list to the user,
and analyze an emotional state of the user by using an emotion analysis engine based on input information received from the user via the user terminal, and reflect an analysis result of the emotional state in at least one of the computation of the destination candidates and the generation of the packing list.

### Supplementary 2

The system according to supplementary 1,
wherein the processor is configured to
acquire, from the storage device, the travel history information and the preference information of the user, execute an analysis process using the acquired travel history information and preference information as input data, automatically generate, based on a result of the analysis process, the prompt sentence that instructs generation of the destination candidates, and input the prompt sentence into the generative AI model to cause the generative AI model to generate the destination candidates.

### Supplementary 3

The system according to supplementary 1,
wherein the processor is configured to
generate context information by combining the location information, the schedule information, the weather information, and travel purpose information related to a travel of the user, automatically generate, based on the context information, the prompt sentence that instructs generation of the packing list including the classification information and the explanation information, input the prompt sentence into the generative AI model to cause the generative AI model to generate the packing list, and transmit the generated packing list to the user terminal so as to notify the packing list to the user.

Application Example 2

### Supplementary 1

A system comprising a processor,
wherein the processor is configured to
receive user information including behavior information, history information, and attribute information from a user terminal,
generate a prompt sentence for a generative AI model by using the user information as input, input the prompt sentence to the generative AI model, and cause the generative AI model to generate travel destination candidate information reflecting user preferences and user emotional states,
execute reservation processing for an accommodation means and a transportation means via an application programming interface of an external reservation service on the basis of the travel destination candidate information, and acquire reservation result information, execute settlement processing using an external electronic payment service on the basis of the reservation result information, and acquire settlement result information,
acquire weather data from an external weather information service by using location information and date information corresponding to a planned travel location or a current location,
generate a prompt sentence for the generative AI model by using the weather data, the user information, and travel purpose information as input, input the prompt sentence to the generative AI model, and cause the generative AI model to generate packing list information corresponding to weather conditions and a travel purpose,
notify the packing list information to the user terminal and cause display or management of the packing list information on the user terminal, estimate an emotional state of the user by inputting text information or voice information of the user to an emotion analysis engine, and include the emotional state in a prompt sentence to be input to the generative AI model so as to change the travel destination candidate information and the packing list information in accordance with the emotional state, and
store the prompt sentence input to the generative AI model, an output result generated by the generative AI model, and selection information or operation information by the user in association with each other, and update a generation rule or a control parameter for the prompt sentence on the basis of the stored information so as to improve, in a learning manner, a proposal accuracy of the travel destination candidate information and the packing list information.

### Supplementary 2

The system according to supplementary 1,
wherein the processor is configured to
acquire past travel history information and preference information of the user from a storage means, generate context information including the past travel history information, the preference information, a current emotional state, and current input conditions, generate a prompt sentence embedding the context information, and input the prompt sentence to the generative AI model so as to cause the generative AI model to generate travel destination candidate information suitable for the user.

### Supplementary 3

The system according to supplementary 1,
wherein the processor is configured to
use context information including weather data, period information, activity type information, and emotional state information to generate a prompt sentence defining generation conditions for a packing list, input the prompt sentence to the generative AI model so as to cause the generative AI model to generate packing list information corresponding to weather conditions, a season, a travel purpose, and an emotional state, and transmit the generated packing list information to the user terminal as notification information.

What is claimed is:

1. A system comprising:
circuitry configured to:
receive input information from a user terminal;
acquire history information and preference information associated with a user from a storage device based on user identification information derived from the input information;
numeralize the history information and the preference information as feature quantities to generate user feature information;
generate a first prompt sentence embedding the user feature information together with the input information;
input the first prompt sentence to a generative artificial intelligence model to cause the generative artificial intelligence model to generate structured candidate information representing a ranked set of candidate destinations;
rank the structured candidate information based on a scoring function applied to the structured output and present the ranked candidate information to the user terminal;
receive selected destination information from the user terminal;
construct context information comprising weather prediction information acquired from an external weather information service for the selected destination and a movement period, the selected destination information, and user attribute information;
generate a second prompt sentence encoding the context information and a travel-purpose type;
input the second prompt sentence to the generative artificial intelligence model to obtain portable article candidate information; and
post-process the portable article candidate information by performing at least duplicate-item removal, classification assignment, and display-format conversion to generate portable article information and present the portable article information to the user terminal.

2. The system of claim 1, wherein the circuitry is configured to:
analyze at least one of text information and audio information included in the input information using an emotion analysis engine to generate an emotion analysis result; and
dynamically adjust content of at least one of the first prompt sentence and the second prompt sentence based on the emotion analysis result to modify at least one of the candidate information and the portable article candidate information.

3. The system of claim 2, wherein the emotion analysis engine applies a sentiment analysis model to extract an emotional state of the user from natural language expressions in the input information, the emotional state comprising at least one of a positive state, a negative state, a neutral state, and a stressed state.

4. The system of claim 3, wherein the circuitry is configured to:
incorporate information representing the emotional state into the first prompt sentence as an additional embedding field; and
re-input the first prompt sentence augmented with the emotional state into the generative artificial intelligence model to adjust a distribution of candidate destinations based on the emotional state.

5. The system of claim 4, wherein the circuitry is configured to:
iteratively update a travel plan and the portable article information in response to additional condition inputs from the user terminal by generating revised first and second prompt sentences and supplying the revised prompt sentences to the generative artificial intelligence model.

6. The system of claim 1, wherein numeralizing the history information and the preference information comprises applying a feature extraction algorithm to convert categorical preference attributes and historical event records into numerical feature vectors.

7. The system of claim 6, wherein generating the first prompt sentence comprises serializing the numerical feature vectors together with the input information into a structured text representation formatted according to a template that instructs the generative artificial intelligence model to generate destination candidate information in a machine-parseable output format.

8. The system of claim 1, wherein the weather prediction information is obtained by querying the external weather information service with the selected destination information and the movement period as query parameters, and wherein the weather prediction information comprises at least a temperature range, a precipitation probability, and a seasonal indicator.

9. The system of claim 8, wherein generating the second prompt sentence comprises encoding the temperature range, the precipitation probability, the seasonal indicator, and the travel-purpose type into a structured prompt template that instructs the generative artificial intelligence model to enumerate items appropriate for the indicated weather conditions and travel purpose.

10. The system of claim 1, wherein the circuitry is configured to:
update the history information in the storage device based on content presented to the user terminal for use in subsequent prompt generation for the generative artificial intelligence model.

11. The system of claim 1, wherein the generative artificial intelligence model comprises a large language model trained to generate text responses to input prompts, and wherein the generative artificial intelligence model is accessed via a network interface.

12. The system of claim 11, wherein inputting the first prompt sentence to the generative artificial intelligence model comprises transmitting a prompt request payload via an application programming interface of the generative artificial intelligence model and receiving a text response containing the structured candidate information.

13. The system of claim 1, wherein post-processing the portable article candidate information further comprises applying a natural language parsing algorithm to extract individual item tokens from the output of the generative artificial intelligence model prior to duplicate-item removal.

14. The system of claim 13, wherein classification assignment assigns each extracted item token to a category from a predefined taxonomy comprising at least clothing, electronics, documents, and personal care items.

15. The system of claim 2, wherein the emotion analysis engine applies at least one of a recurrent neural network model, a transformer-based sentiment classifier, or a lexicon-based scoring algorithm to derive the emotion analysis result from the natural language expressions.

16. The system of claim 1, wherein user attribute information comprises at least a preferred budget range, preferred climate type, and historical destination frequency data derived from the history information.

17. The system of claim 1, wherein the circuitry is configured to:
rank the structured candidate information based on a composite score computed from at least a preference alignment score derived from the user feature information and a contextual relevance score derived from the input information.

18. A system comprising:
circuitry configured to:
receive input information from a user terminal;
acquire history information and preference information from a storage device and numeralize the history information and the preference information as feature quantities to generate user feature information;
generate a first prompt sentence embedding the user feature information and input the first prompt sentence to a generative artificial intelligence model to generate structured candidate information representing ranked candidate destinations;
acquire weather prediction information from an external weather information service and generate a second prompt sentence encoding the weather prediction information and a travel-purpose type;
input the second prompt sentence to the generative artificial intelligence model to obtain portable article candidate information and post-process the portable article candidate information by performing duplicate-item removal, classification assignment, and display-format conversion to generate portable article information; and
analyze at least one of text information and audio information using an emotion analysis engine to generate an emotion analysis result and dynamically adjust content of at least one of the first prompt sentence and the second prompt sentence based on the emotion analysis result.

19. The system of claim 18, wherein the circuitry is configured to apply a feature extraction algorithm to convert categorical preference attributes and historical event records of the user into numerical feature vectors, and to serialize the numerical feature vectors into the first prompt sentence as structured embedding fields.

20. A method performed by circuitry, the method comprising:
receiving input information from a user terminal;
acquiring history information and preference information from a storage device based on user identification information and numeralizing the history information and the preference information as feature quantities to generate user feature information;
generating a first prompt sentence embedding the user feature information together with the input information and inputting the first prompt sentence to a generative artificial intelligence model to generate structured candidate information representing ranked candidate destinations;
acquiring weather prediction information from an external weather information service and constructing context information comprising the weather prediction information, a selected destination, and a travel-purpose type;
generating a second prompt sentence encoding the context information and inputting the second prompt sentence to the generative artificial intelligence model to obtain portable article candidate information;
post-processing the portable article candidate information by performing duplicate-item removal, classification assignment, and display-format conversion to generate portable article information; and
analyzing at least one of text information and audio information using an emotion analysis engine to generate an emotion analysis result and dynamically adjusting content of at least one of the first prompt sentence and the second prompt sentence based on the emotion analysis result.
